(19) United States
(12) Patent Application Publication
(10) Pub. No.: US 2022/0287245 A1
(43) Pub. Date: Sep. 15, 2022

(54) ELECTROMAGNETIC TREATMENT OF CROPS

(71) Applicant: BRIGHT YETI, INC., Denver, CO (US)

(72) Inventors: Jacob CORDOVA, Denver, CO (US); Jake KERR, Denver, CO (US)

(21) Appl. No.: 17/633,906

(22) PCT Filed: Aug. 7, 2020
(86) PCT No.: PCT/US2020/045310

§ 371 Date: Feb. 8, 2022

Related U.S. Application Data
(60) Provisional application No. 62/884,778, filed on Aug. 9, 2019.

(51) Int. Cl. A01G 7/04

(52) U.S. Cl. CPC A01G 7/04

(57) ABSTRACT

Disclosed herein are methods and systems for electromagnetic treatment of a plant. The electromagnetic treatment can improve or modify plant growth, development, chemical profile, appearance, tolerances, etc. The electromagnetic treatment can also reduce plant pests.

### CROSS REFERENCE TO RELATED PATENT APPLICATIONS

This application claims the benefit of priority to U.S. Provisional Patent Application Ser. No. 62/884,778, filed Aug. 9, 2019, hereby incorporated by reference in its entirety.

### BACKGROUND OF THE INVENTION

### A. Field of the Invention

The field of the invention is plant system treatments. Specifically, electromagnetic plant treatments that can include modification of any characteristic of a plant or modification of the behavior or survivability of plant pests.

### B. Description of Related Art

By 2050, the human population of the world is expected to increase by more than 35%. It is projected that crop production will need to at least double to feed the world's population in 2050. Currently, chemical or organic fertilizers and pesticides can be used to increase crop production. However, in many cases, fertilizers must be tailored for the specific soil type and climate where the crop is produced and pesticides must be carefully regulated and carefully used. Further, fertilizers and pesticides can have unwanted effects on the environment and the crop production itself. For example, over fertilization can increase growth of unwanted organisms at the treatment area and downstream and can cause depletion of other nutrients in the soil that are not replaced by the fertilizer itself. Resistance to pesticides can occur and pesticides can be detrimental to beneficial organisms in the treatment area or downstream. In addition, some fertilizers, when left on the crop plant can be harmful to human health when contacted or consumed. Also concerning is the likelihood that increasing the world's crop production by the means currently available is not likely to keep up with demand.

Some have attempted to increase crop production or improve desirable characteristics of plants by genetically modifying plants or changing the growth conditions of the plant. Genetic modification can occur through selective breeding, screening plants for desired traits, mutational breeding, gene transfer, gene editing, etc. Some of these modification methods are considered undesirable or unacceptable by some consumers. Further, some of these modification methods are expensive and take many years to develop.

Overall, the need for improvements in this field persists in light of at least the aforementioned drawbacks for the currently available methods and systems.

### SUMMARY OF THE INVENTION

A solution to at least some of the above-mentioned problems associated with improving plant system characteristics (including ions in plants and microorganisms inside, outside, associated with, attached to, plants on leaves, fruits, roots, etc.) and decreasing losses due to pests has been discovered. The solution resides in electromagnetic treatments of plants. Disclosed herein are electromagnetic treatment recipes, methods of treatments, and systems and apparatuses to treat plants with said electromagnetic treatments. It has been found that the treatments can modify mass of at least a portion of the plant, yield of the plant, germination rate, germination timing, membrane permeability, nutrient uptake, gene transcription, gene expression, cell growth, cell division, protein synthesis, latent heat flux, carbon assimilation, stomatal conductance, quantum efficiency of PSII reaction centers, efficiency of energy harvesting by oxidized PSII reaction centers, variable fluorescence, fluorescence value at first inflection point, latent heat flux, sensible heat flux, net thermal balance, transpiration rate, CO2 assimilation rate, intercellular CO2, stomatal conductance to water vapor, boundary layer conductance to water vapor, total conductance to water vapor, total conductance to CO2, steady-state fluorescence, maximum fluorescence, quantum yield of photosystem II, electron transport rate, quantum yield calculated from CO2 assimilation, non-photochemical quenching, photochemical quenching, non-photochemical quenching, fluorescence rate of change, initial fluorescence yield, the chemical profile in at least a portion of the plant, the time required for harvest readiness, rooting development rate, water use efficiency, nutrient use efficiency, time to develop mature flowers, time to set fruit, plant height, plant width, ratio of vegetative tissue to flower tissue, ratio of vegetative tissue to fruit tissue, quantity of flowering, lateral organs, and/or vegetative node sites, internode spacing, attracting or increasing the amounts of beneficial organisms, and/or repel and/or decrease the amount of pests on the plant, as compared to a plant that is not treated.

In one aspect, a plant treatment system is disclosed. A “plant” may refer to either the adult plant, seedlings, or seeds. The treatment system can be capable of producing any of the electromagnetic plant treatments disclosed herein. In some instances, the treatment system includes a function generator configured to generate an electromagnetic field. The function generator may be any component capable of producing a voltage output, and that voltage output, when applied to a radiating structure, generates the electromagnetic field for plant treatment. The function generator may generate an arbitrary voltage output to be an electromagnetic signal according to a predetermined or programmable recipe. The recipes may be dynamic and adjust to conditions. For example, if one recipe works best for the first 4 weeks of a plants life during seedling and root development, then a separate recipe works best for the last 4 weeks of a plants life for vegetative development, the system can automatically adjust recipes for the user. In some embodiments, the function generator may generate an electromagnetic signal by modulating a carrier wave. In some embodiments, the function generator may be controlled by a single timer and/or sensor or a combination of timers and/or sensors. In other embodiments, the function generator may be controlled by a computational system configured to receive an input specifying parameters for controlling the function generator and to control the function generator to generate an electromagnetic field according to the input. In some embodiments, the function generator may be a transformer. In some instances, the treatment system can receive instructions for a treatment recipe wirelessly from a central server. The central server may control any aspect of the electromagnetic plant treatment system. The central server may be, for example, a cloud-based management system with AI/machine learning capability or a simple remote control. The treatments system can also receive instructions for more than one treatment recipe. The treatment system, in some instances, can change the electromagnetic recipe delivered by the system. In this way, the same system can be used to provide treatment to a plant at different stages of growth or development, can be used to treat the same plant with different recipes that target a variety of different modifications that target to a variety of different organisms and/or biological process modifications, and/or can be used to treat different plants.

In one aspect, an electromagnetic plant treatment is disclosed. The electromagnetic plant treatment can include an electromagnetic field comprising a carrier frequency and a carrier waveform. In some instances, a carrier is not used. Optionally, the electromagnetic filed can be modulated with a modulating wave to produce a modulated electromagnetic field. In some instances, the electromagnetic field is not modulated. The modulating wave can have a modulating frequency, a modulating waveform, and/or an amplitude modulating index. In some instances, the electromagnetic treatment, at least in part, mimics or enhances naturally occurring changes that can occur in the plant, pest, environment, organisms, or other biological processes. In some instances, the treatment may mimic in part an ion cyclotron resonance frequency of an ion such as calcium, potassium, magnesium, iron, copper, and/or nitrogen. In some instances, the electromagnetic treatment mimics in part an environmental change, such as, but not limited to a change in ion concentration or electromagnetic field that occurs due to a storm (e.g., increase/decrease in voltage due to the storm).

In another aspect, a method of treating a plant is disclosed. The method can include treating a plant with any one of the electromagnetic plant treatments disclosed herein. In some instances, the method is carried out at least in part by any one of the treatment systems disclosed herein. The plant treated can be any plant, such as a crop plant, an ornamental plant, a medicinal plant, or a plant used for beneficial uses such as ground cover, reduction of soil erosion the receding or changing of shores or banks, providing shade or shelter, reintroduction or increasing the number of plants or plant species in an area, etc. The treatment can be applied, stopped, or modified according to a timing, environmental change, plant life cycle, event such as watering, trigger of a sensor, etc., or can be constant.

Also disclosed are the following Embodiments 1 to 86 of the present invention.

Embodiment 1 is a plant treatment system configured to treat a plant with an electromagnetic field, the system comprising: a function generator configured to generate the electromagnetic field; and one or more radiating structure(s) coupled to the function generator and configured to produce the electromagnetic field for applying to the plant.

Embodiment 2 is the plant treatment system of Embodiment 1, further comprising a computational system configured to receive an input specifying parameters for controlling the function generator and to control the function generator to generate an electromagnetic field according to the input.

Embodiment 3 is the plant treatment system of Embodiment 2, wherein the computational system is configured to receive a recipe comprising the parameters for controlling the function generator and the parameters specifying a voltage and a optionally a modulating wave.

Embodiment 4 is the plant treatment system of any one of Embodiments 2 and 3, wherein the computational system is configured to receive more than one recipe comprising the parameters for controlling the function generator and the parameters specifying a carrier wave and a optionally a modulating wave, and control the function generator to generate any one or more of the more than one recipe.

Embodiment 5 is the plant treatment system of any one of Embodiments 2 to 4, wherein the computational system is configured to receive a schedule for applying the electromagnetic field to the plant.

Embodiment 6 is the plant treatment system of Embodiment 5, wherein the computational system is configured to change the electromagnetic field in accordance with the schedule.

Embodiment 7 is the plant treatment system of any one of Embodiments 2 to 6, wherein the computational system comprises a wireless communication component and is configured to wirelessly receive a recipe and/or schedule.

Embodiment 8 is the plant treatment system of Embodiment 7, wherein the recipe is encrypted.

Embodiment 9 is the plant treatment system of any one of Embodiments 1 to 8, wherein the function generator comprises a Software Defined Radio (SDR) or a transformer.

Embodiment 10 is the plant treatment system of any one of Embodiments 1 to 9, wherein the system is configured to produce an electromagnetic field.

Embodiment 11 is the plant treatment system of any one of Embodiments 1 to 10, wherein at least one radiating structure is positioned in close proximity to a plant.

Embodiment 12 is the plant treatment system of any one of Embodiments 1 to 11, wherein at least one radiating structure is positioned within 15 feet of a plant.

Embodiment 13 is the plant treatment system of any one of Embodiments 1 to 12, wherein at least one radiating structure comprises copper, galvanized steel, and/or or aluminum.

Embodiment 14 is the plant treatment system of any one of Embodiments 1 to 13, wherein at least one radiating structure comprises a transmission line, pipe, coil, capacitor, point source antenna, mesh, grounding stake, tape, foil, plate, and/or standard antenna.

Embodiment 15 is the plant treatment system of any one of Embodiments 1 to 14, wherein the one or more radiating structure comprises a plurality of radiating structures.

Embodiment 16 is the plant treatment system of Embodiment 15, wherein at least two of the plurality of radiating structures are at least in part parallel with each other.

Embodiment 17 is the plant treatment system of Embodiment 16, wherein the at least two radiating structures comprise parallel transmission lines, parallel pipes, parallel meshes, parallel plates, and/or parallel coils.

Embodiment 18 is the plant treatment system of Embodiment 17, wherein the parallel coils are Helmholtz coils.

Embodiment 19 is the plant treatment system of any one of Embodiments 1 to 18, wherein at least one radiating structure is positioned horizontally or vertically.

Embodiment 20 is a method of treating a plant, the method comprising: producing a treatment electromagnetic field using the plant treatment system of any one of Embodiments 1 to 19; and applying the treatment electromagnetic field to a plant.

Embodiment 21 is a method for electromagnetic treatment of a plant, the method comprising: producing an electromagnetic field; and applying the electromagnetic field to a plant.

Embodiment 22 is the method of Embodiment 21, wherein producing the electromagnetic field comprises modulating a carrier frequency of 0 Hz to 5.875 GHz with a modulating wave to produce the electromagnetic field, wherein the modulating wave comprises a waveform with a modulating frequency of 0 Hz to 1 MHz, a modulating waveform, and/or an amplitude modulating index of 0% to 120%.

Embodiment 23 is the method of any one of Embodiments 21 to 22, wherein the electromagnetic field matches the ion cyclotron resonance frequency of calcium, potassium, magnesium, iron, copper, and/or nitrogen during at least a portion of the treatment.

Embodiment 24 is the method of any one of Embodiments 22 to 23, wherein the modulated electromagnetic field has a sine carrier frequency, amplitude modulated at 50 Hz, a square wave modulation waveform, and/or 30% amplitude modulating index, or any combination thereof.

Embodiment 25 is the method of any one of Embodiments 21 to 24, wherein the treatment is provided as a constant treatment or a treatment that is turned on and/or off or changed with watering cycles for the plant, set timing, an environmental change, and/or stage of the life of the plant.

Embodiment 26 is the method of any one of Embodiments 22 to 25, wherein the amplitude of the modulated electromagnetic field produced an electromagnetic field configured to be dampened by tissue of the plant.

Embodiment 27 is the method of any one of Embodiments 22 to 26, wherein modulating the electromagnetic field modulates the carrier amplitude and/or the carrier frequency.

Embodiment 28 is the method of any one of Embodiments 21 to 27, wherein the treatment comprises a magnetic field.

Embodiment 29 is the method of any one of Embodiments 21 to 27, wherein the treatment comprises a an electric field, wherein the electric field produced has a strength of −1 MV/m to 1 MV/m at a location where the electric field is produced.

Embodiment 30 is the method of any one of Embodiments 21 to 29, wherein the carrier waveform and/or a modulating waveform is static, pulsed, square, sine, triangular, sawtooth, damped pulse, rectangular, ramped, cardiogram, or amplitude varying, or any combination thereof.

Embodiment 31 is the method of any one of Embodiments 21 to 30, wherein the electromagnetic field produced has a strength of at least −110 dBm to at least 20 dBm at a location where the electromagnetic field is produced.

Embodiment 32 is the method of any one of Embodiments 22 to 31, wherein the method further comprises modulating strength of the modulated electromagnetic field.

Embodiment 33 is the method of any one of Embodiments 21 to 32, wherein the treatment is applied to a plant for 1 microsecond to 1440 minutes per day.

Embodiment 34 is the method of any one of Embodiments 21 to 33, wherein the treatment is applied to a plant for at least one day to 12 months.

Embodiment 35 is the method of any one of Embodiments 21 to 34, wherein the electromagnetic field is produced by at least one of the radiating structure(s).

Embodiment 36 is the method of Embodiment 35, wherein at least one radiating structure is positioned in close proximity to the plant.

Embodiment 37 is the method of any one of Embodiments 35 to 36, wherein at least one radiating structure is positioned within 15 feet of the plant.

Embodiment 38 is the method of any one of Embodiments 35 to 37, wherein at least one radiating structure is positioned within 3 feet of the plant

Embodiment 39 is the method of any one of Embodiments 35 to 38, wherein at least one radiating structure comprises a transmission line, pipe, coil, capacitor, point source antenna, mesh, grounding stake, tape, foil, plate, and/or standard antenna.

Embodiment 40 is the method of any one of Embodiments 35 to 39, wherein the at least one radiating structure comprises a plurality of radiating structures.

Embodiment 41 is the method of Embodiment 40, wherein at least two of the plurality of radiating structures are at least in part parallel with each other.

Embodiment 42 is the method of Embodiment 41, wherein the at least two radiating structures comprise parallel transmission lines, parallel pipes, parallel coils, parallel antenna, parallel wire meshes, parallel grounding stakes, parallel tapes, parallel foils, and/or parallel plates.

Embodiment 43 is the method of Embodiment 42, wherein the parallel coils are Helmholtz coils.

Embodiment 44 is the method of any one of Embodiments 35 to 43, wherein at least one radiating structure is positioned horizontally or vertically.

Embodiment 45 is the method of any one of Embodiments 21 to 44, wherein the electromagnetic field mimics a change in the ambient electromagnetic field due to a storm.

Embodiment 46 is the method of any one of Embodiments 21 to 45, wherein the method modifies weight of at least a portion of the plant, yield of the plant, germination rate, germination timing, membrane permeability, nutrient uptake, gene transcription, gene expression, cell growth, cell division, protein synthesis, latent heat flux, carbon assimilation, stomatal conductance, the chemical profile in at least a portion of the plant, the time required for harvest readiness, quantity of flowering sites, internode spacing, and/or repel and/or decrease the amount of pests on the plant, as compared to a plant that is not treated.

Embodiment 47 is the method of any one of Embodiments 21 to 46, wherein the treatment is applied to the plant when the plant is a seed, a synthetic seed, a cutting, a seedling, a mature plant, a plant in a flowering stage, a plant in a vegetative stage, and/or a plant in a fruiting stage.

Embodiment 48 is the method of any one of Embodiments 21 to 47, wherein the plant belongs to a kingdom Plantae.

Embodiment 49 is the method of any one of Embodiments 21 to 48, wherein the plant belongs to a subkingdom Viridiplantae or any cultivar or subspecies thereof.

Embodiment 50 is the method of any one of Embodiments 21 to 48, wherein the plant belongs to a infrakingdom Streptophta or any cultivar or subspecies thereof.

Embodiment 51 is the method of any one of Embodiments 21 to 48, wherein the plant belongs to a superdivision Embryophyta or any cultivar or subspecies thereof.

Embodiment 52 is the method of any one of Embodiments 21 to 48, wherein the plant belongs to a division Tracheophyta or any cultivar or subspecies thereof.

Embodiment 53 is the method of any one of Embodiments 21 to 48, wherein the plant belongs to a subdivision Spermatophytina or any cultivar or subspecies thereof.

Embodiment 54 is the method of any one of Embodiments 21 to 48, wherein the plant belongs to a class Magnoliopsida or any cultivar or subspecies thereof.

Embodiment 55 is the method of any one of Embodiments 21 to 48, wherein the plant belongs to a superorder selected from Rosanae and Asteranae, or any cultivar or subspecies thereof.

Embodiment 56 is the method of any one of Embodiments 21 to 48, wherein the plant belongs to an order selected from Rosales, Brassicales, Asterales, Vitales, and Solanales or any cultivar or subspecies thereof.

Embodiment 57 is the method of any one of Embodiments 21 to 48, wherein the plant belongs to a family selected from Brassicaceae, Asteracae, Vitacaea, Cannabaceae, and Solanacaea or any cultivar or subspecies thereof.

Embodiment 58 is the method of any one of Embodiments 21 to 48, wherein the plant belongs to a genus selected from Humulus, Brassica, Eruca, Lactuca, Cannabis, Vitis, and Solanum or any cultivar or subspecies thereof.

Embodiment 59 is the method of any one of Embodiments 21 to 48, wherein the plant belongs to a species Humulus japonicus, Humulus lupulus, Cannabis sativa, Cannabis indica, Cannabis ruderalis, Brassica rapa, Eruca vesicaria, Lactuca biennis, Lactuca canadensis, Lactuca floridana, Lactuca graminifolia, Lactuca hirsute, Lactuca indica, Lactuca ludoviciana, Lactuca X morssii, Lactuca sagilina, Lactuca sativa, Lactuca serriola, Lactuca terrae-novae, Lactuca virosa, Vitis acerifolia, Vitis aestivalis, Vitis amurensis, Vitis arizonica, Vitis X bourquina, Vitis californica, Vitis X champinii, Vitis cinerea, Vitis coriacea, Vitis X doaniana, Vitis girdiana, Vitis labrusca, Vitis X labruscana, Vitis monticola, Vitis mustangensis, Vitis X novae-angliae, Vitis palmata, Vitis riparia, Vitis rotundifolia, Vitis rupestris, Vitis shuttleworthii, Vitis tillifolia, Vitis vinifera, Vitis vulpina, and Solanum lycopersicum, or any cultivar or subspecies thereof.

Embodiment 60 is the method of any one of Embodiments 21 to 48, wherein the plant is a lettuce, arugula, bok choy, tomato, grape, hops, hemp, or mizuna, or any cultivar or subspecies thereof.

Embodiment 61 is the method of any one of Embodiments 21 to 48, wherein the plant is spinach, sunflower, canola, flax corn, rice, wheat, oat, barley, soybean, bean, pea, legume, chickpea, sorghum, sugar cane, sugar beet, cotton, potato, turnip, carrot, onion, cantaloupe, watermelon, blueberry, cherry, apple, pear, peach, cacti, date, fig, coconut, almond, walnut, pecan, cilantro, broccoli, cauliflower, zucchini, squash, pumpkin, or any cultivar or subspecies thereof.

Embodiment 62 is the method of any one of Embodiments 21 to 48, wherein the plant is a tomato plant, a lettuce plant, a strawberry plant, a saffron plant, or a grape plant.

Embodiment 63 is the method of any one of Embodiments 21 to 62, wherein the electromagnetic field comprises a sine carrier waveform, and the modulating wave applied to the carrier waveform comprises a waveform with a modulating frequency of 16 Hz, a modulating waveform of square, and/or an amplitude modulating index of 30%, and wherein mass of the plant and/or a part of the plant is increased as compared to a plant not treated by the method.

Embodiment 64 is the method of Embodiment 63, wherein the plant is a tomato plant and the mass of a tomato fruit is increased.

Embodiment 65 is the method of any one of Embodiments 21 to 62, wherein the electromagnetic field comprises a field that matches an ion cyclotron resonance frequency of K⁺ during at least a portion of the treatment, the electromagnetic field comprises a sine carrier waveform, and the modulating wave applied to the carrier waveform comprises a waveform with a modulating frequency of 50 Hz, a modulating waveform of square, an amplitude modulating index of 10%, and/or a nominal field strength of 127.31 micro tesla, and wherein germination rate is increased as compared to a plant not treated by the method.

Embodiment 66 is the method of Embodiment 65, wherein the plant is a tomato plant.

Embodiment 67 is the method of any one of Embodiments 21 to 62, wherein the electromagnetic field is generated by modulating a carrier wave with a DC signal, and/or has a nominal field strength of 150 micro tesla, and wherein mass of the plant and/or part of the plant is increased, as compared to a plant not treated by the method.

Embodiment 68 is the method of Embodiment 67, wherein the plant is a lettuce plant and the total plant vegetative mass is increased.

Embodiment 69 is the method of any one of Embodiments 21 to 62, wherein the electromagnetic field comprises a field that matches an ion cyclotron resonance frequency of K⁺ during at least a portion of the treatment, the electromagnetic field comprises a sine carrier waveform, and the modulating wave comprises a waveform with a modulating frequency of 16 Hz, a modulating waveform of sawtooth, an amplitude modulating index of 30%, and/or a nominal field strength of 40.74 micro tesla, and wherein mass of the plant and/or part of the plant is increased, as compared to a plant not treated by the method.

Embodiment 70 is the method of Embodiment 69, wherein the plant is a lettuce plant and the total plant vegetative mass is increased.

Embodiment 71 is the method of any one of Embodiments 21 to 62, wherein the electromagnetic field comprises a field that matches an ion cyclotron resonance frequency of Mg²⁺ during at least a portion of the treatment, the electromagnetic field comprises a sine carrier waveform, and the modulating wave comprises a waveform with a modulating frequency of 60 Hz, a modulating waveform of square, an amplitude modulating index of 10%, and/or a nominal field strength of 47.48 micro tesla, and wherein mass of the plant and/or part of the plant is increased, as compared to a plant not treated by the method.

Embodiment 72 is the method of Embodiment 71, wherein the plant is a lettuce plant and the total plant vegetative mass is increased.

Embodiment 73 is the method of any one of Embodiments 21 to 62, wherein the electromagnetic field comprises a sine carrier waveform, and the electromagnetic field comprises a waveform with a modulation frequency of 50, a modulating waveform of sine, an amplitude modulating index of 30%, and/or a nominal field strength of 150 micro tesla, and wherein mass of the plant and/or part of the plant is increased, as compared to a plant not treated by the method.

Embodiment 74 is the method of Embodiment 73, wherein the plant is a lettuce plant and the total plant vegetative mass is increased.

Embodiment 75 is the method of any one of Embodiments 21 to 62, wherein the electromagnetic field comprises a field that matches an ion cyclotron resonance frequency of Mg²⁺ during at least a portion of the treatment, the electromagnetic field comprises a sine carrier waveform, and the modulating wave comprises a waveform with a modulating frequency of 50 Hz, a modulating waveform of sine, an amplitude modulating index of 30%, and/or a nominal field strength of 39.57 micro tesla, and wherein mass of the plant and/or part of the plant is increased, as compared to a plant not treated by the method.

Embodiment 76 is the method of Embodiment 75, wherein the plant is a lettuce plant and the total plant vegetative mass is increased.

Embodiment 77 is the method of any one of Embodiments 21 to 62, wherein the electromagnetic field comprises a field that matches an ion cyclotron resonance frequency of K⁺ during at least a portion of the treatment, the electromagnetic signal comprises a DC signal modulated by a waveform with a modulating frequency of 60 Hz, a modulating waveform of sine, an amplitude modulating index of 30%, and/or a nominal field strength of 152.8 micro tesla, and wherein a pest is repelled and/or the number of pests on and/or in the plant is decreased, as compared to a plant not treated by the method.

Embodiment 78 is the method of Embodiment 77, wherein the pest is an aphid and/or spider mite.

Embodiment 79 is the method of any one of Embodiments 21 to 62, wherein the electromagnetic field comprises a field that matches an ion cyclotron resonance frequency of N⁺ during at least a portion of the treatment, the electromagnetic field comprises a sine carrier waveform, and the modulating wave comprises a waveform with a modulating frequency of 50, a modulating waveform of sine, an amplitude modulating index of 30%, and/or a nominal field strength of 45.61 micro tesla, and wherein mass of the plant and/or part of the plant is decreased, as compared to a plant not treated by the method.

Embodiment 80 is the method of Embodiment 79, wherein the plant is a lettuce plant and the total plant vegetative mass is decreased.

Embodiment 81 is the method of any one of Embodiments 21 to 62, wherein the electromagnetic field comprises a field that matches an ion cyclotron resonance frequency of Fe²⁺ during at least a portion of the treatment, the electromagnetic field comprises a sine carrier waveform, and the modulating wave comprises a waveform with a modulating frequency of 50, a modulating waveform of sine, an amplitude modulating index of 30%, and/or a nominal field strength of 90.92 micro tesla, and wherein mass of the plant and/or part of the plant is decreased, as compared to a plant not treated by the method.

Embodiment 82 is the method of Embodiment 81, wherein the plant is a lettuce plant and the total plant vegetative mass is decreased.

Embodiment 83 is the method of any one of Embodiments 21 to 62, wherein the electromagnetic field comprises a field that matches an ion cyclotron resonance frequency of Cu²⁺ during at least a portion of the treatment, the electromagnetic field comprises a sine carrier waveform, and the modulating wave comprises a waveform with a modulating frequency of 50, a modulating waveform of sine, an amplitude modulating index of 30%, and/or a nominal field strength of 103.45 micro tesla, and wherein mass of the plant and/or part of the plant is decreased, as compared to a plant not treated by the method.

Embodiment 84 is the method of Embodiment 83, wherein the plant is a lettuce plant and the total plant vegetative mass is decreased.

Embodiment 85 is the method of any one of Embodiments 21 to 84, wherein the total consumption of energy to produce the modulated electromagnetic field is 1000 watts/100 ft² or less, preferably 100 watts/100 ft² or less, or more preferably 75 watts/100 ft² to 50 watts/100 ft², or more preferably 40 watts/100 ft² to 60 watts/100 ft².

Embodiment 86 is the method of any one of Embodiments 21 to 85, further comprising producing the modulated electromagnetic field by the plant treatment system of any one of Embodiments 1 to 20.

The following includes definitions of various terms and phrases used throughout this specification.

The terms “about,” “approximately,” and “substantially” are defined as being close to, as understood by one of ordinary skill in the art. In one non-limiting instance, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume, or the total moles of material that includes the component. In a non-limiting example, 10 grams of a component in 100 grams of the material that includes the component is 10 wt. % of component.

The use of the words “a” or “an” when used in conjunction with any of the terms “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The compositions and process of the present invention can “comprise,” “consist essentially of,” or “consist of” particular ingredients, components, compositions, etc., disclosed throughout the specification. With respect to the transitional phase “consisting essentially of,” in one non-limiting aspect, a basic and novel characteristic of the treatment systems and plant treatments disclosed herein is that the treatments modify plants through contacting the plant with an electromagnetic field designed to modify the plant and the systems herein are capable of producing said treatments. In some instances, the systems are capable of receiving instructions for treatments and producing said treatments.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes, combinations, and modifications within the spirit and scope of the invention will become apparent to those skilled in the art from this detailed description.

### BRIEF DESCRIPTION OF THE DRAWINGS

Advantages of the present invention may become apparent to those skilled in the art with the benefit of the following non-limiting detailed description and upon reference to the accompanying non-limiting drawings. The drawings may not be to scale.

FIGS. 1A-1I show a block diagram for electromagnetic treatment recipe delivery systems according to some embodiments of the disclosure.

FIGS. 2A-2D show example radiating structures for delivery of electromagnetic fields to plants according to some embodiments of the disclosure.

FIGS. 3A-3O show other example radiating structures for delivery of electromagnetic fields to plants according to some embodiments of the disclosure.

FIG. 4 shows a system for transmission of electromagnetic treatment recipes and/or authorization codes according to some embodiments of the disclosure.

FIG. 5 shows a flow chart for performing transactions involving electromagnetic treatment recipes according to some embodiments of the disclosure.

FIG. 6 shows a system for secured transactions and encrypted transmission of electromagnetic treatment recipes and/or authorization codes according to some embodiments of the disclosure.

FIG. 7 is a block diagram illustrating an electromagnetic treatment recipe delivery system involving multiple radiating structures according to some embodiments of the disclosure.

### DETAILED DESCRIPTION OF THE INVENTION

Electromagnetic treatment recipes, methods of treatments, and systems and apparatuses to treat plants with said electromagnetic treatments disclosed herein have been developed to modify weight of at least a portion of the plant, yield of the plant, germination rate, germination timing, membrane permeability, nutrient uptake, gene transcription, gene expression, cell growth, cell division, protein synthesis, latent heat flux, carbon assimilation, stomatal conductance, the chemical profile in at least a portion of the plant, the time required for harvest readiness, quantity of flowering sites, internode spacing, and/or repel and/or decrease the amount of pests on the plant, as compared to a plant that is not treated. In some instances, the electromagnetic treatment, at least in part, mimics or enhances naturally occurring changes that can occur in the plant, pest, or environment. As a non-limiting example, the treatment may mimic in part an ion cyclotron resonance frequency of an ion such calcium, potassium, magnesium, iron, copper, and/or nitrogen. As another non-limiting example, the electromagnetic treatment mimics in part an environmental change, such as, but not limited to a change in ion concentration or electromagnetic field that occurs due to a storm (e.g., increase in voltage due to the storm).

### A. System and Apparatus to Deliver Treatment Recipe

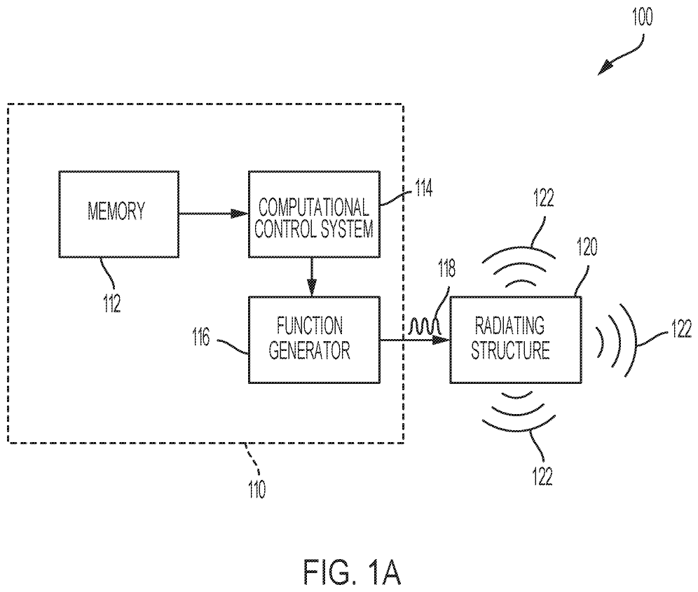

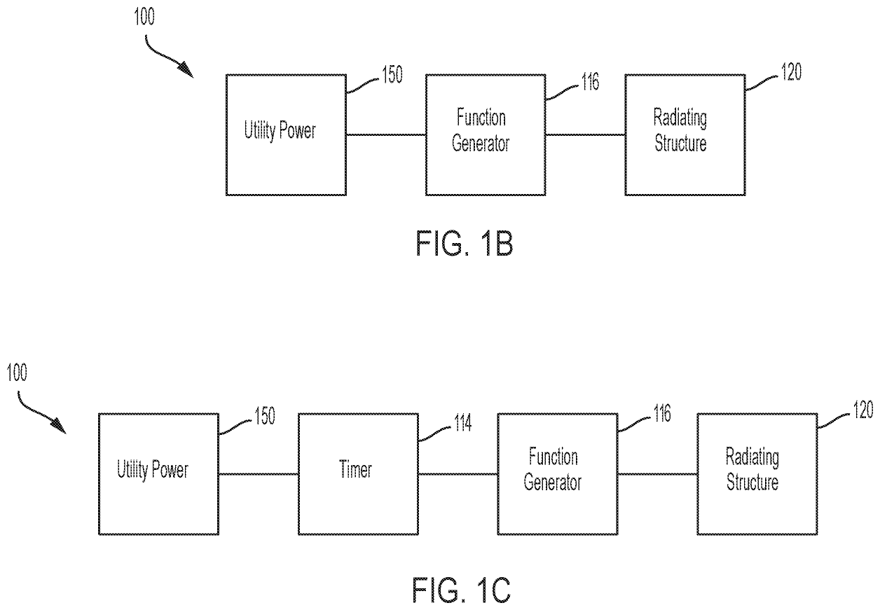

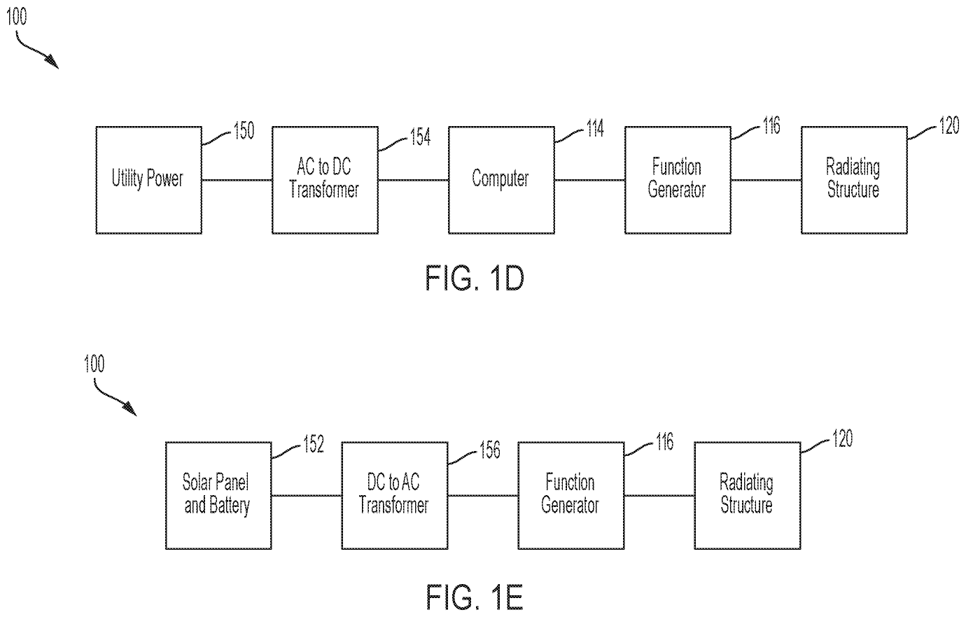

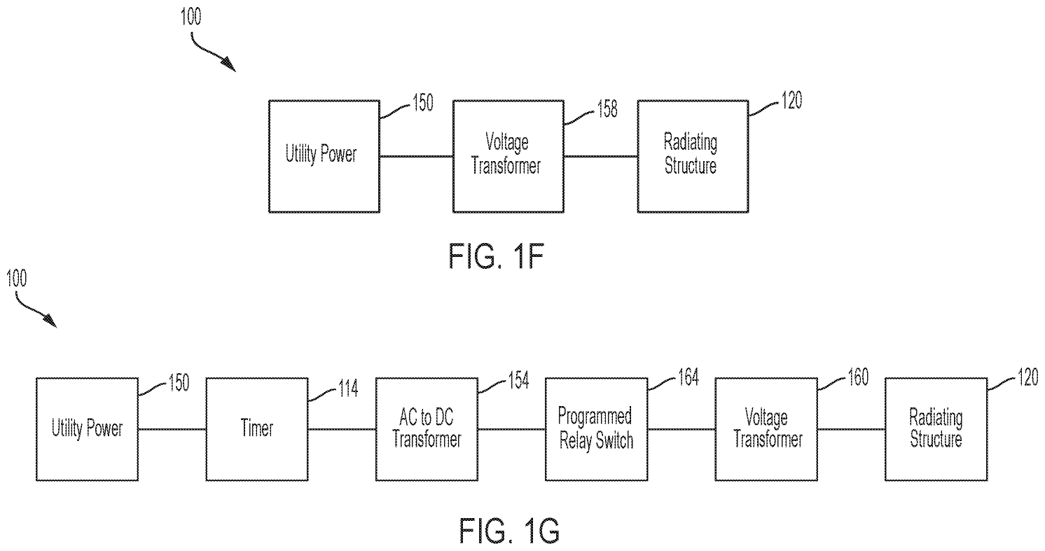

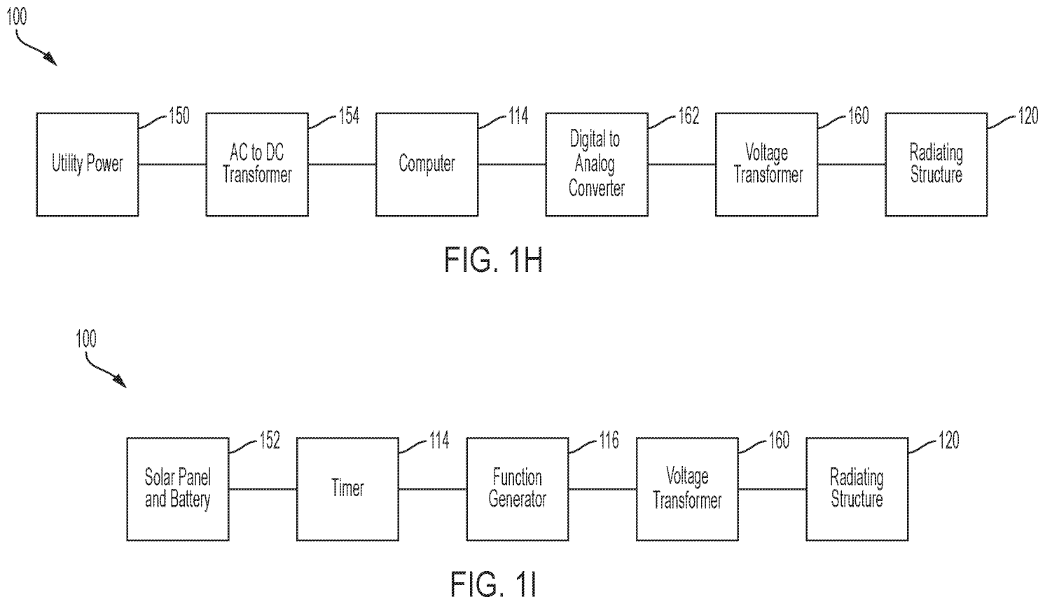

FIG. 1A shows a block diagram for an electromagnetic treatment recipe delivery system according to some embodiments of the disclosure. The treatment system 100 can be capable of producing any of the electromagnetic plant treatments disclosed herein. The treatment system 100 includes a function generator 116 configured to generate an electromagnetic signal 118, which when applied to radiating structure 120 produces an electromagnetic field 122, which can be a modulated electromagnetic field or other electromagnetic field created by the recipes disclosed herein.

The system 100 also includes a computational system 114 configured to receive an input specifying the electromagnetic field and optionally the modulating wave and control the function generator 116 to generate the electromagnetic field 122. the function generator 116 may be, for example, a software defined radio (SDR), a transformer, or another waveform generation circuit. The input to the function generator 116 may be a decoded electromagnetic treatment recipe that specifies parameters such as voltage, amplitude, carrier frequency, modulation pattern, etc. The function generator 116 may produce the electromagnetic signal 118 by generating a carrier wave in accordance with the recipe and then optionally modulating the carrier wave in accordance with the recipe.

The electromagnetic treatment recipe may be stored in memory 112, where the recipe is read out by the computational system 114 and decoded. In some embodiments, the treatment system can receive instructions for a treatment recipe wirelessly. In some embodiments, the treatment system stores a recipe book, and individual recipes within the book are unlocked by wireless communications or entering codes into the user system 110. The treatments system 100 can also receive instructions for more than one treatment recipe. The treatment system 100, in some instances, can change the electromagnetic recipe. In this way, the same system can be used to provide treatment to a plant at different stages of growth or development, can be used to treat the same plant with different recipes that target a variety of different plant/pest modifications, and/or can be used to treat different plants. In some embodiments, the user system 110 may also include a communications adapter, such as a wireless communications adapter, to perform functions described in more detail below.

Other examples of electromagnetic treatment recipe delivery systems are shown in FIGS. 1B-1I. Other configurations for the system may include different forms of computational systems, no computational system, different power sources, and/or different power conversion systems. Any configuration of the electromagnetic treatment recipe delivery systems is configured to operate a radiating structure to cause generation of an electromagnetic field to a plant at levels and times specified by a recipe (either pre-programmed or programmable). FIG. 1B shows a block diagram for an electromagnetic treatment recipe delivery system with a radiating structure 120 powered by function generator 116 fed by utility power 150. In the embodiment of FIG. 1B, the function generator is configured, such as by being pre-programmed, to generate a particular electromagnetic signal, and can be delivered on-site and plugged in to operate without any further configuring. FIG. 1C shows a block diagram for an electromagnetic treatment recipe delivery system with a radiating structure 120 powered by a function generator 116 controlled by timer 114 and fed by utility power 150. In the embodiment of FIG. 1C, the desired electromagnetic field of the electromagnetic treatment recipe is pre-configured in the function generator 116 and the desired schedule for the electromagnetic field is pre-configured in the timer 114. FIG. 1D shows a block diagram for an electromagnetic treatment recipe delivery system with a radiating structure 120 powered by a function generator 116 coupled to a computational control system 114 and fed by utility power 150 and AC-to-DC transformer 154. FIG. 1E shows a block diagram for an electromagnetic treatment recipe delivery system with a radiating structure 120 powered by a function generator 116 fed by solar panel and battery 152 and DC-to-AC transformer 156.

FIG. 1F shows a block diagram for an electromagnetic treatment recipe delivery system with a radiating structure 120 powered by a voltage transformer 158 fed by utility power 150. The voltage transformer 158 may be configured to output an electromagnetic signal according to a fixed recipe. In one example, the transformer may be configured to output a voltage and hold it constant for a certain amount of time. In another example, the transformer may be configured to output and fluctuate a voltage using an arbitrary noise waveform. FIG. 1G shows a block diagram for an electromagnetic treatment recipe delivery system with a radiating structure 120 powered by a voltage transformer 160 coupled to a programmed relay switch 164 coupled to an AC-to-DC transformer 154 coupled to a timer 114 and fed by utility power 150. The fixed electromagnetic field generated by the radiating structure 120 may be toggled according to a pre-programmed schedule using the timer 114 and the programmed relay switch 164. FIG. 1H shows a block diagram for an electromagnetic treatment recipe delivery system with a radiating structure 120 powered by a voltage transformer 160 coupled to a digital-to-analog converter (DAC) 162 controlled by a computational control system 114 fed by utility power 150 and AC-to-DC transformer 154. FIG. 1I shows a block diagram for an electromagnetic treatment recipe delivery system with a radiating structure 120 powered by a voltage transformer 160 coupled to a function generator 116 coupled to a timer 114 fed by a solar panel and battery 152. The function generator 116 may be pre-programmed with a recipe for creating a desired electromagnetic field from the radiating structure 120 and generated in accordance with a schedule programmed in timer 114.

### 1. Radiating Structures

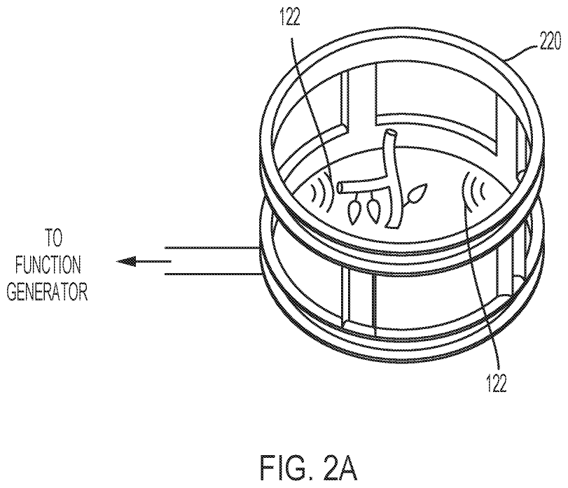

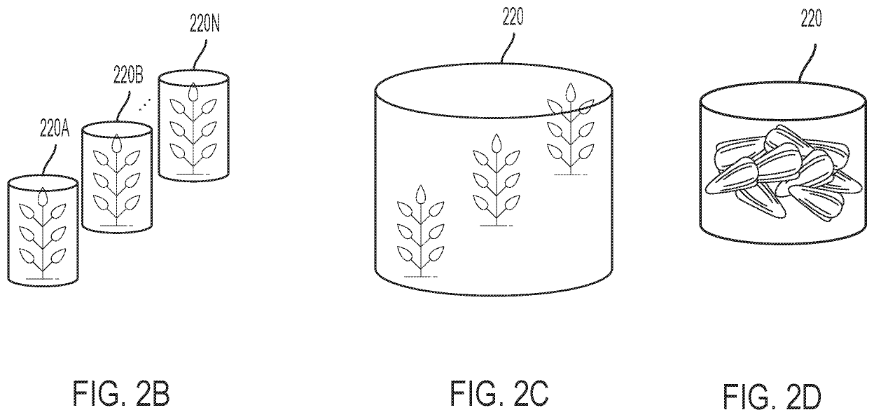

Radiating structure 120 shown in FIGS. 1A-1I can be any structure that delivers an electromagnetic field to the plants. FIGS. 2A-2D show example radiating structures involving coils. One example radiating structure is shown in FIG. 2A. FIG. 2A shows an example radiating structure for delivery of electromagnetic fields to plants according to some embodiments of the disclosure. A coil 220 may be coupled to radiate an electromagnetic field in accordance with an electromagnetic signal generated by the function generator. The coil 220 may be sized to fit around an individual plant, similar to protective fencing placed around trees or tomato plants. The coil 220 may be used to generate static magnetic fields upon the application of a static signal (e.g., DC or 0 Hz) signal by the function generator. FIG. 2B shows an embodiment with coils 220A-N each arranged around a different one of a plurality of plants. FIG. 2C shows an embodiment with a coil 220 arranged around a plurality of plants. FIG. 2D shows an embodiment with a coil 220 arranged around seeds.

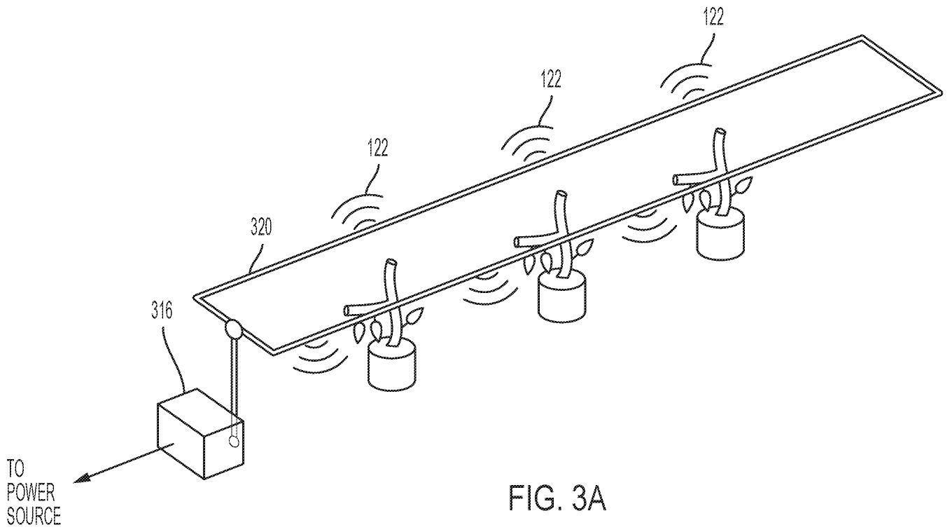

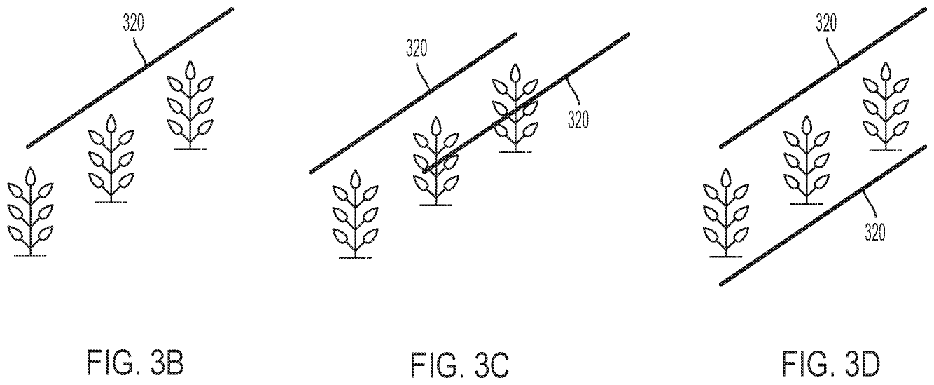

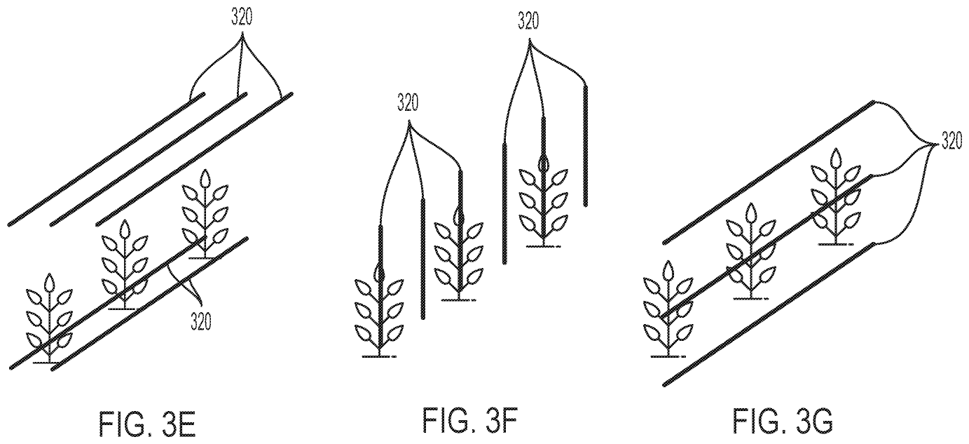

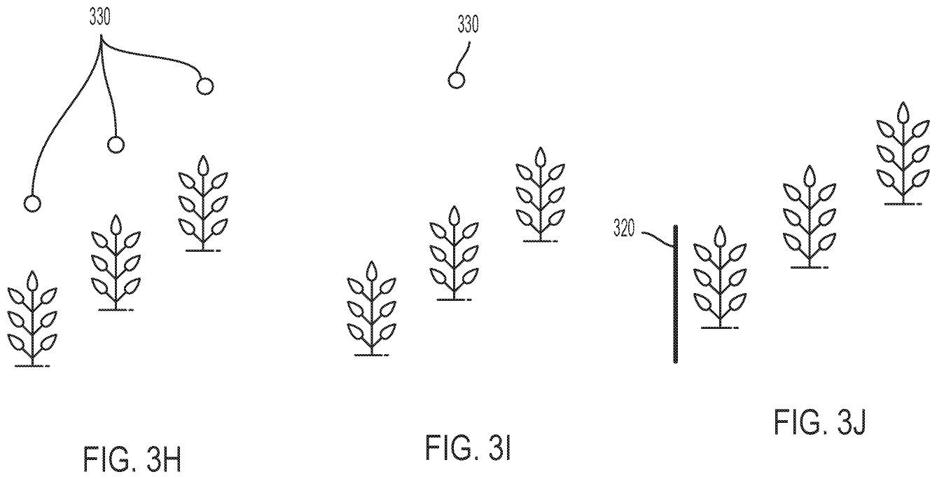

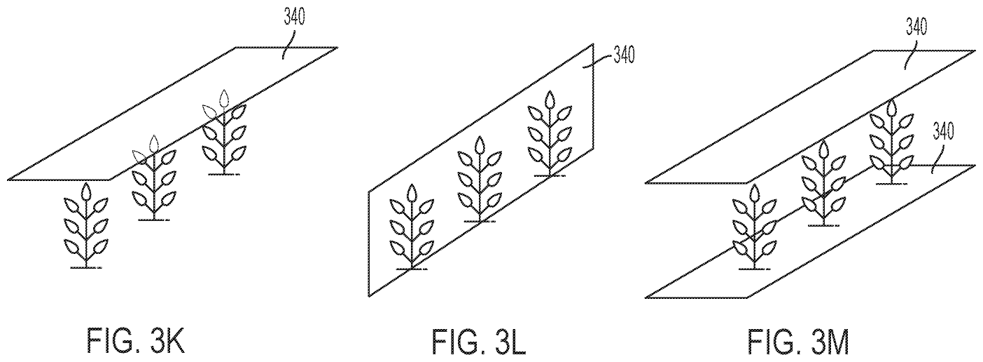

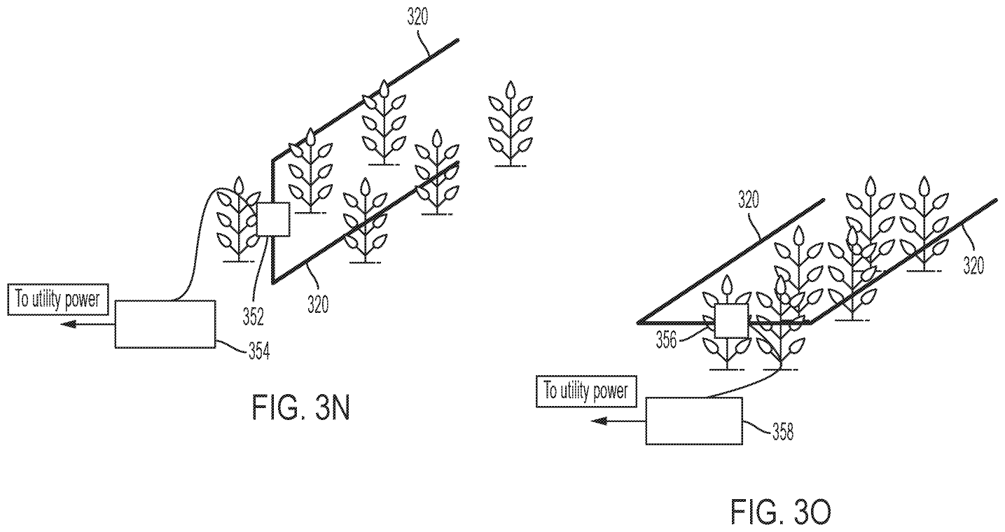

Other example radiating structures are shown in FIG. 3A-3O that include plate, grids, nets, meshes, point, wire and/or other configurations. FIG. 3A shows another example radiating structure for delivery of electromagnetic fields to plants according to some embodiments of the disclosure. Wires 320 are positioned in parallel over a row or table of plants. The wires 320 are coupled to radiate an electromagnetic field in accordance with an electromagnetic signal generated by the electromagnetic treatment system 316. Multiple radiating structures of the same or different type may be coupled together to operate under control of a computational control system to support various sizes of nurseries. Other radiating structures for use in the system 100 include a structure positioned in close proximity, such as within 15 feet, to a plant, a structure comprising a metal or other radiating material, such as copper, galvanized steel, and/or or aluminum, a structure comprising a single or multiple line(s), wire(s), pipe(s), coil(s), mesh(es), plate(s), capacitor(s), point source antenna(s), chip antenna(s), spiral antenna(s), strip line antenna(s), grounding stake(s), tape(s), foil(s), and/or standard antenna(s), a structure comprising a plurality of electrically conductive material structures, structures that are at least in part parallel with each other, structures comprising parallel transmission lines, parallel pipes, parallel plate, parallel meshes, and/or parallel coils (e.g., Helmholtz coils), and/or structures positioned horizontally or vertically. In some embodiments, radiating structures may be placed in wires or pipes that are encapsulated in PVC or fiber glass pipes/tubes.

FIG. 3B shows a configuration with a wire 320 overhead, although the wire 320 could alternatively be below or within the height of the plant. FIG. 3C shows a configuration with parallel wires 320 side-by-side, which may be overhead, below, or within the height of the plant. FIG. 3D shows a configuration with two wires 320, one of which is over the plant and another of which is below the plant. FIG. 3E shows a configuration with multiple wires 320 overhead and/or below the plants. FIG. 3F shows a configuration with multiple wires 320 vertical to the ground and spread throughout the plants. FIG. 3G shows a configuration with multiple wires 320 spread throughout the height of the plants, and/or above and below the plant. FIG. 3H shows a configuration with multiple points 330 with each overhead, in the middle, or below individual plants. FIG. 3I shows a configuration with a single point 330 arranged overhead, in the middle, or below multiple plants. FIG. 3J shows a configuration with a single or multiple wires 320 arranged throughout a room for treating multiple plants.

In some embodiments, the wires for a radiating structure may be arranged in a grid configuration and/or may be a plate. FIG. 3K shows a configuration with a horizontal grid and/or plate 340 overhead or below plants. FIG. 3L shows a configuration with one or more vertical grids and/or plate 340 arranged through the plants. FIG. 3M shows a configuration with one or more horizontal grids and/or plates 340 positioned overhead and below the plants, although some embodiments may also include vertical grids.

FIGS. 3N-3O show embodiments for connecting wire-based electromagnetic systems to utility power. In FIG. 3N, wires 320 are positioned over the plants and below the plants. The wires 320 couple to electric box 352, which includes a high voltage transformer. The electric box 352 couples to electric box 354, which includes a programmable relay switch, two AC-to-DC transformers, a timer, a surge protector, and/or power splitters, configured such as in the embodiments shown in FIGS. 1A-1I. The electric box 354 is plugged into utility power or another power source to begin delivery of the electromagnetic field treatment to the plants. One receipt that can be implemented using FIG. 3N is a sub-continuous schedule involving the system being on for 2 hours, starting approximately 4 hours after plants are watered, with the treatment beginning six hours after perceived sunrise, for a duration of 53 days, with a target electric field strength of −5 Kv/m delivered from a transformer with a pulse ON time of 0.5 seconds and a pulse off time of 10 seconds, which has been shown to produce a 31% yield mass increase on flowering plants. In other embodiments for producing an electric field, the electric field may have a strength of −1 MV/m to 1 MV/m at a location where the electric field is produced.

In FIG. 3O, wires 320 are positioned in parallel side-by-side around plants. The wires 320 are coupled to electric box 356, which may include a balun. The electric box 356 is coupled to electric box 358, which may include a function generator, a fan, a surge protector, and/or power splitters, configured such as in the embodiments shown in FIGS. 1A-1I.

2. Recipe Delivery

Referring back to the electromagnetic treatment recipe delivery system 100 of FIG. 1, the function generator produces electromagnetic signal 118 based on controls provided by computational system 114, which may be a processor, DSP, ASIC, or other electronic circuitry. A set of controls may be referred to as a recipe, and specify characteristics of the electromagnetic signal that the function generator 116 produces. These recipes can be entered through a control panel attached to the delivery system, such as to provide switches, knobs, graphical user interface display, and other input devices for manually programming parameters such as the time the system is on and treating the plants, field “strength” in terms of voltage, tesla, or dBm, target ion, etc. These recipes can be stored in memory 112 and recalled as desired, such as at intervals specified by the recipes. In some embodiments, the recipes are remotely delivered to the system 110 and stored in memory 112. In different embodiments, the memory 112 may store a recipe book of available recipes that can be read-out as needed or only a small set of recipes, such as those purchased by the user, are stored in the memory 112. In some embodiments, the recipe may be delivered through a network to the system 110 and deleted immediately after the recipe is used by the function generator. The recipes may represent valuable data that should be protected from unauthorized access or unauthorized modification.

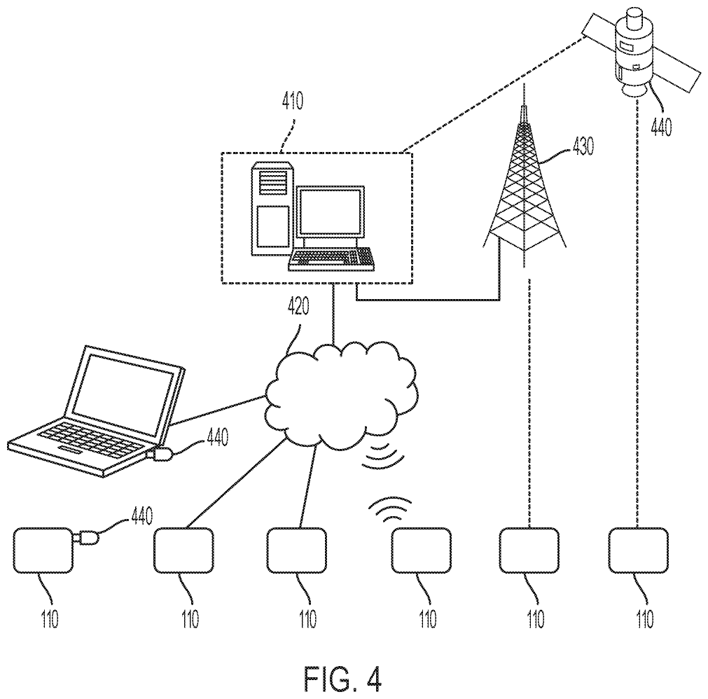

In some embodiments, the recipes may thus be maintained at a central facility from which the recipes or authorization codes to unlock certain recipes from a recipe book are provided to users of electromagnetic treatment recipe delivery systems. FIG. 4 shows a system for transmission of electromagnetic treatment recipes and/or authorization codes according to some embodiments of the disclosure. A server 410 may store and/or generate recipes and/or authorization codes for recipes. For example, the server 410 may maintain a recipe book from which individual recipes can be distributed to user systems 110. As another example, the server 410 may maintain a recipe book and distribute updates to recipes or recipe books stored on user systems 110. As a further example, the server 410 may store authorization codes that when provided to user systems 110 unlock certain recipes or certain functionality. As another example, the server 410 may generate and distribute authorization codes on demand based on other data, such as a unique serial number of a user system 110 or a key stored on a user system 110.

The server 410 may distribute information, including recipes or authorization codes, to the user systems 110 through a variety of techniques. In one example, the server 410 may connect to the user systems 110 through a public network 420, such as the Internet, through wired or wireless communications. In another example, the server 410 may connect to the user systems 110 through a proprietary radio transmission tower 430. In a further example, the server 410 may connect to the user systems 110 through satellite relay 440. In another example, the server 410 may connect to the user systems 110 through removable media, such as a USB data storage dongle 440. A user may use another computing device to obtain a secured recipe, code, key, or certificate that is loaded on the dongle 440 and coupled to the user system 110 for read-out.

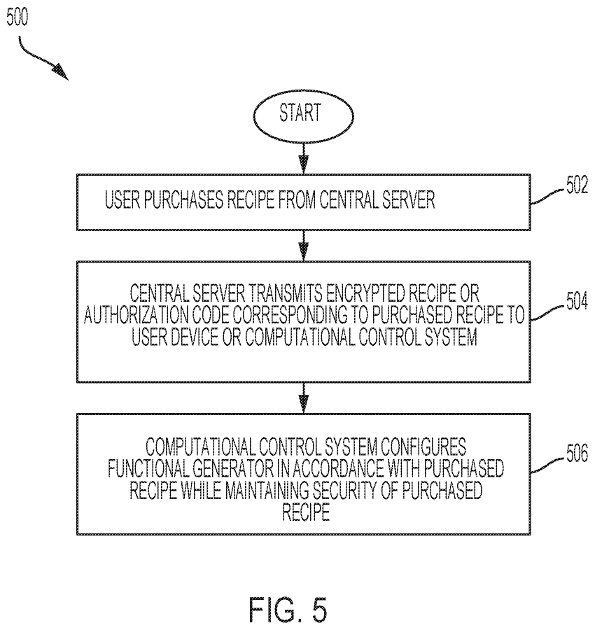

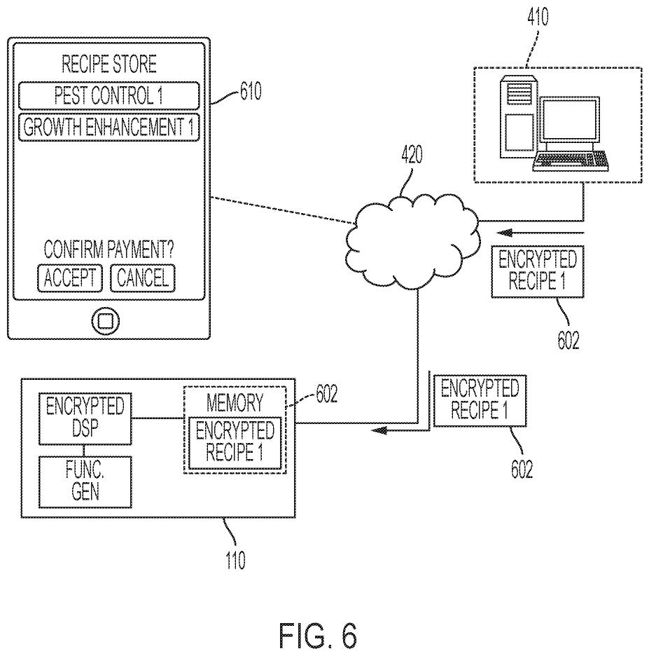

One example transaction for unlocking recipes in the electromagnetic treatment recipe delivery systems is shown in FIG. 5. FIG. 5 shows a flow chart for performing transactions involving electromagnetic treatment recipes according to some embodiments of the disclosure. A method 500 begins at step 502 with a user purchasing a recipe from a server. The method 500 is further illustrated in FIG. 6. FIG. 6 shows a system for secured transactions and encrypted transmission of electromagnetic treatment recipes and/or authorization codes according to some embodiments of the disclosure. A user may purchase recipes through a user interface that provides access to server 410. For example, a user's mobile device 610 may have a recipe store, similar to an app store, that provides menus to allow a user to select recipes, such as a “Pest Control 1” recipe and a “Growth Enhancement 1” recipe. The user's mobile device 610 may also facilitate payment for the recipe. Through communication with the server 410, the server 410 can confirm payment for the recipe and then arrange for transmission of the recipe to the user system 110. Other input from a user used for identifying a recipe may include selection by an automated server or user application, entry by a sales consultant, selection by phone or email system, and/or entry by a user on a web page form.

At step 504, the server 410 transmits the encrypted recipe or authorization code corresponding to the purchased recipe to a user device for loading to a computational system or directly to a computational system, such as the computational control system 114 of user system 110. An encrypted recipe 602 may be transmitted by the server 410 over the public network 420 to a user system 110. Example embodiments for delivery of the recipe may include transmission over the air (OTA), delivery of a recipe to a user or technician to manual enter the recipe in the plant treatment system, and/or delivery of a file to be loaded into the plant treatment system. The recipes can be monetized through business models such as software as a service (SaaS), a subscription model wherein the farm subscribes to a specific recipe and pays a monthly fee for use based on what they are growing and how much area they want treated, a lease model, and/or a direct sale model.

At block 506, the user system 110 decodes the recipe or code and configures the function generator 116 in accordance with the purchased recipe. Steps performed in the transmission of the recipe or code and performed in the storing and processing of data within the user system 110 may be performed in a manner to maintain security of the purchased recipe. For example, the recipe when stored in the memory 112 may be stored as encrypted data that cannot be read as plain text. The computational control system 114 of the user system 110 may be an encrypted digital signal processor (DSP) with a trusted platform module (TPM) that may assist in the reading and securing of the recipes. When desired or scheduled, the encrypted DSP decodes the recipe and provides control signals to the functional generator 116 to produce an electromagnetic signal. In some embodiments, the computational control system 114 may provide secure systems for logging number of uses of each recipe and transmitting the logged data back to the server 410. In one example, a schedule for the application of electromagnetic fields may be included in the recipe, where the exposure to electromagnetic fields is not intended to be continuous. In another example, a recipe may specify exposure to electromagnetic fields of different characteristics during different period of time during a day, a week, a month, or a year.

3. Multiple Radiating Structure Configurations

For large installations of plant nurseries that exceed the power output capability of a single user system 110, power amplifiers may be distributed throughout a location to power separate radiating structures within the location. For example, one function generator may be coupled to multiple power amplifiers and transformers throughout the location. As another example, a location may have four different grow rooms in one facility, wherein the plant treatment system includes one computer, four amplifiers, and 64 transformers in one arrangement, or four computers, 64 amplifiers, and 64 transformers in another arrangement, or four computers, four amplifiers, and 16 transformers in yet another arrangement.

Another example is a farm with 4 different grow rooms in one facility. We might have 1 computer, 4 amplifiers, and 64 transformers in such an arrangement. Or we could have 4 computers, 64 amplifiers and 64 transformers. Another arrangement might include 4 computers, 4 amplifiers, and 16 transformers.

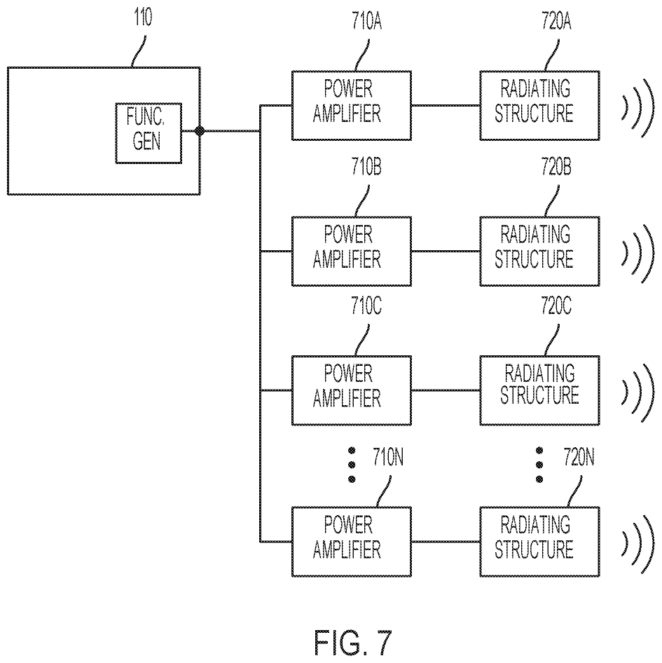

One example setup is shown in FIG. 7. FIG. 7 is a block diagram illustrating an electromagnetic treatment recipe delivery system involving multiple radiating structures according to some embodiments of the disclosure. A user system 100 includes a functional generator 116 that provides an output signal comprising an electromagnetic signal that when applied to a radiating structure produces an electromagnetic field conducive to plant growth, pest deterrence, or other beneficial result. The electromagnetic signal may be a digital or analog signal supplied to a plurality of power amplifiers 710A-N that amplify the signal. The amplified signal is then applied to radiating structures 720A-N, respectively. In some embodiments, the power amplifiers 710A-N may include security measures that allow the power amplifiers 710A-N to be verified by the user system 110 before they can receive the electromagnetic signal from the functional generator. In some embodiments, this verification may be used by the functional generator to log an amount of use of a particular recipe, which can then be reported to the server 410 for billing or informational purposes.

### B. Treatment Recipe

Some or all of the electromagnetic plant treatments described herein can be produced by any of the treatment systems described herein. The plant treatments can include an electromagnetic field comprising a carrier frequency and a carrier waveform. In some instances, a carrier is not used. The electromagnetic filed can be modulated with a modulating wave to produce a modulated electromagnetic field. In some instances, the electromagnetic field is not modulated. The modulating wave can have a modulating frequency, a modulating waveform, and/or an amplitude modulating index.

1. Carrier Waveform:

Any carrier waveform can be used when a carrier wave is used. Carrier waveforms that can be used include, but are not limited to, static, pulsed, square, sine, triangular, sawtooth, damped pulse, rectangular, ramped, cardiogram, or amplitude varying.

2. Carrier Frequency:

The carrier frequency of the treatment can be any frequency from 0 Hz to 6 Ghz. The carrier frequency can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 Hz, or any range thereof or frequency there between. The carrier frequency can be 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 KHz, or any range thereof or frequency there between. The carrier frequency can be 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 MHz, or any range thereof or frequency there between. The carrier frequency can be 1, 2, 3, 4, 5, or 6 GHz, or any range thereof or frequency there between. The carrier frequency can be any range of the frequencies in this paragraph or frequency there between. In some instances, the carrier frequency is 0 Hz to 5.875 GHz, 0 to 200 Hz, 1 to 17 MHz, 1.4 to 15.1 MHz, 40 to 55 MHz, 45 to 50 MHz, 48 to 49 MHz, or 48.468 MHz. In some instances, the carrier frequency is a frequency with the Industrial, Scientific, and Medical (ISM) frequency bands. The ISM frequency bands can be frequencies designated as defined by the ITU Radio Regulations. The ISM frequency bands can include frequencies set aside for uses other than for telecommunications, though some of these frequencies have be used for telecommunications.

Not to be bound by theory, but it is believed that use of a carrier frequency that is dampened by tissue of the plant treated may help provide benefits to the plant. In some instances, the carrier frequency used is the frequency that is most dampened by plant tissue. Additionally or alternatively, the electromagnetic treatments may stimulate or otherwise affect microorganisms inside, outside, associated with, attached to, plants on leaves, fruits, roots, etc. that affect the growth and vitality of the plant.

3. Modulation Wave and Waveform:

The modulating wave, when used, can modulate the carrier wave's frequency and/or amplitude. In some instances, the modulating wave modulates the carrier's frequency. In some instances, the modulation wave modulates the carrier's amplitude. In some instances, the modulation wave modulates the carrier's frequency and amplitude. In other instances, the modulation may include amplitude modulation, frequency modulation, phase modulation, amplitude-shift keying, frequency-shift keying, phase-shift keying, and/or pulse width modulation.

Any modulation waveform can be used when a modulation wave is used. Modulation waveforms that can be used include, but are not limited to pulsed, square, sine, triangular, sawtooth, static, damped pulse, rectangular, ramped, cardiogram, or amplitude varying. In some instances, the modulation waveform is square.

Not to be bound by theory, but it is believed that use of a modulating waveform may help increase the response of a plant's cellular processes to the electromagnetic treatment.

4. Modulation Frequency:

The modulation wave frequency of the treatment can be any frequency. In some instances, the modulation frequency is from 0 Hz to 6 GHz. The modulation frequency can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 Hz, or any range thereof or frequency there between. The modulation frequency can be 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 KHz, or any range thereof or frequency there between. The modulation frequency can be 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 MHz, or any range thereof or frequency there between. The modulation frequency can be 1, 2, 3, 4, 5, or 6 GHz, or any range thereof or frequency there between. The modulation frequency can be any range of the frequencies in this paragraph or frequency there between. In some instances, the modulation frequency is 0 to 200 Hz. In some instances, the modulation frequency is 188, 60, 50, 16, or 0 Hz. In some instances, the modulation frequency is 50 Hz.

5. Amplitude Modulation:

The amplitude of a carrier wave can be modified to provide an amplitude modulated wave. The amplitude of the carrier wave can be modified from 0% to 120%. The amplitude can be modified 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120%, or any range thereof or amplitude therebetween. In some instances, the modulation is in a square, sine, or sawtooth waveform pattern. In some instances, the amplitude is not modified. In some instances, the amplitude is modified from 5% to 50%. In some instances, the amplitude is modified 30%.

### C. Method of Use

The electromagnetic treatment recipes, methods of treatments, and systems and apparatuses to treat plants with said electromagnetic treatments disclosed herein have been found to modify weight of at least a portion of the plant, yield of the plant, germination rate, germination timing, membrane permeability, nutrient uptake, gene transcription, gene expression, cell growth, cell division, protein synthesis, latent heat flux, carbon assimilation, stomatal conductance, the chemical profile in at least a portion of the plant, the time required for harvest readiness, quantity of flowering sites, internode spacing, and/or repel and/or decrease the amount of pests on the plant, as compared to a plant that is not treated.

1. Plants

The plant treated can be any plant, such as a crop plant, an ornamental plant, a medicinal plant, lumber trees, or a plant used for beneficial uses such as ground cover, reduction of soil erosion the receding or changing of shores or banks, providing shade or shelter, reintroduction or increasing the number of plants or plant species in an area, etc.

In some embodiments, the plant is selected from any plant of the kingdom Plantae. In embodiments, the plant belongs to the subkingdom Viridiplantae. In embodiments, the plant belongs to the infrakingdom Streptophta. In embodiments, the plant belongs to the superdivision Embryophyta. In embodiments, the plant belongs to the division Tracheophyta. In embodiments, the plant belongs to the subdivision Spermatophytina. In embodiments, the plant belongs to the class Magnoliopsida. In embodiments, the plant belongs to a superorder selected from Rosanae and Asteranae. In embodiments, the plant belongs to an order selected from Rosales, Brassicales Asterales, Vitales, and Solanales. In embodiments, the plant belongs to a family selected from Brassicaceae, Asteracae, Vitacaea, Solanacaea, and Cannabaceae. In embodiments, the plant belongs to a genus selected from Humulus, Brassica, Eruca, Lactuca, Vitis, Solanum and Cannabis. In embodiments, the plant is selected from the species Humulus japonicus, Humulus lupulus, Brassica rapa, Eruca vesicaria, Lactuca biennis, Lactuca canadensis, Lactuca floridana, Lactuca graminifolia, Lactuca hirsute, Lactuca indica, Lactuca ludoviciana, Lactuca X morssii, Lactuca sagilina, Lactuca sativa, Lactuca serriola, Lactuca terrae-novae, Lactuca virosa, Vitis acerifolia, Vitis aestivalis, Vitis amurensis, Vitis arizonica, Vitis X bourquina, Vitis californica, Vitis X champinii, Vitis cinerea, Vitis coriacea, Vitis X doaniana, Vitis girdiana, Vitis labrusca, Vitis X labruscana, Vitis monticola, Vitis mustangensis, Vitis X novae-angliae, Vitis palmata, Vitis riparia, Vitis rotundifolia, Vitis rupestris, Vitis shuttleworthii, Vitis tillifolia, Vitis vinifera, Vitis vulpina, Cannabis sativa, and Solanum lycopersicum. In embodiments, the plant is a cultivar or subspecies of any of the above referenced species. In embodiments, the plant is selected from any of the plants commonly referred to as lettuce, arugula, bok choy, tomato, cannabis, hemp, grape, hops, spinach, sunflower, canola, flax corn, rice, wheat, oat, barley, soybean, bean, pea, legume, chickpea, sorghum, sugar cane, sugar beet, cotton, potato, turnip, carrot, onion, cantaloupe, watermelon, blueberry, cherry, apple, pear, peach, cacti, date, fig, coconut, almond, walnut, pecan, cilantro, broccoli, cauliflower, zucchini, squash, pumpkin, and mizuna, and any cultivars or subspecies thereof.

2. Pests

The electromagnetic treatment recipes, methods of treatments, and systems and apparatuses disclosed herein in some instances, can deter pests, repel pests, modify the behavior of pests, and/or even kill and/or decrease the fertility of pests. In some instances, the treatment may modify a plant so that the plant itself can deter pests, repel pests, modify the behavior of pests, and/or even kill and/or decrease the fertility of pests.

In some embodiments, the pest can include, but is not limited to, invertebrate pests such as insects, arthropods, mites, and nematodes, fungi, bacteria, animals, or disease causing organisms. Non-limiting examples of pest can include, but are not limited to Achatina fulica, Adelges tsugae, Agrilus planipennis, Ampullaria gigas, Bruchus rufimanus, Callosobruchus maculatus, Cinara cupressi, Dendroctonus valensI, Eriosoma lanigerum, Euglandina rosea, Hemiberlesia pitysophila, Hyphantria cunea, Incisitermes minor, Lehmannia valentiana, Linepithema humile, Liriomyza sativae, Nylanderia fulva, Opogona sacchari, Oracella acuta, Pheidole megacephala, Pomacea canaliculatal, Schistocerca americanaI, Sirex noctilloI, Solenopsis invicta, Solenopsis mandibularis, Trogoderma granariumI, Vespula vulgarisI, Viteus vitifoliae, Wasmannia auropunctatal, Zabrotes subfasciatus, Callosobruchus Chinensis, Sitophilus zeamais, Tribolium castaneum, Epilachna vigintioctomaculata, Agriotes fuscicollis, Anomala rufocuprea, Leptinotarsa decemlineata, Diabrotica spp., Monochamus alternatus, Lissorhoptrus oryzophilus, Lymantria dispar, Malacosoma neustria, Pieris rapae, Spodoptera litura, Mamestra brassicae, Chilo suppressalis, Pyrausta nubilalis, Ephestia cautella, Adoxophyes orana, Carpocapsa pomonella, Galleria mellonella, Plutella maculipennis, Heliothis Phyllocnistis citrella, Nephotettix cincticeps, Nilaparvata lugens, Pseudococcus comstocki, Unaspis yanonensis, Myzus persicae, Aphis pomi, Aphis gossypii, Rhopalosiphum pseuddobrassicas, Stephanitis nashi, Nazara spp., Cimex lectularius, Trialeurodes vaporariorum, Psylla spp., Blatella germanica, Periplaneta americana, Gryllotalpa africana, Locusta migratoria migratoriodes, Reticulitermes speratus, Coptotermes formosanus, Thrips palmi karny, Musaca domestica, Aedes aegypti, Hylemia platura, Culex pipiens, Anopheles sinensis, Culex tritaeniorhynchus, Tetranychus telarius, Panonychus citri, Aculops pelekassi, Tarsonemus spp., Meloidogyne incognita, Bursaphelenchus lignicolus mamiya et kiyohara, Aphelenchoides bessey, Heterodera glycines, Pratylenchus spp., etc. or any related species, such as a species within the same genus or family.

3. Timing

The treatments disclosed herein can be started, stopped, modified, paused, etc. based on a predetermined or programmable schedule and/or a trigger. In some instances, watering, weeding, fertilizing, calendar days, days of the week, time of the day or night, exposure to light, sensors, stage of a plant life, crop cycle, etc. can be used as a trigger. Stages of a plant life include seed, germination, growth, reproduction, pollination, spreading seed, fruiting, harvest, etc. In some instances, environmental changes can be a trigger, such as, but not limited to, air or ground temperature, rain, cloud cover, approaching storm, passage of a storm, change in electromagnetic field such as those that occur with storms, ion concentration, concentration of a chemical or compound, etc.

These and other non-limiting aspects of the present invention are discussed in further detail in the following sections.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### Example 1

### Effect of Modulated EMF on Germination Rate, Total Plant Vegetative Mass, and Total Ripe Fruit Mass of Various Plants

Table 1 shows effect of electromagnetic field (EMF) treatment on various plants. Results were compared with untreated controls grown under similar conditions. Modulated EMF treatment was shown to increased germination rate, and ripe fruit mass for tomato (S. Lycopersicum) plants. Total vegetative mass for lettuce plants (Lactuca sativa) changed based on the treatment recipe.

The ion listed (“Ion” column) indicated that a specific recipe was designed to target that ion's resonant frequency. However, the biological changes in treated plants may not have necessarily occurred due to any changes made to the target ion, including resonance of the ion.

The magnetic field strength targeted in each experiment (“Field Strength, nominal (uT)” column) was determined using a magnetic field sensor for the nominal or “center” strength of the field. A frequency and waveform was applied to oscillate at a specific modulation depth (“Modification Depth (%)” column) as indicated in Table 1. The carrier waveform modulated according to the recipes of Table 1 may be a sine carrier waveform or other voltage signal. The waveform (“Modulation Waveform” column) and frequency of the waveform (“Modulation Frequency (Hz)” column) used for each test is indicated in Table 1

TABLE 1
Effect of EMF Treatment on various plants

| | |
|---|---|
| EMF Treatment | Field |

| | | | | Modulation | | | Modification | Strength, | System | Significant |
|---|---|---|---|---|---|---|---|---|---|---|
| | | Exposure | Duration | Frequency | | Modulation | Depth | nominal | Voltage | Biological |
| Botanical | Strain | (Hrs) | (days) | (Hz) | Ion | Waveform | (%) | (uT) | (VPP) | Effect |
| S. Lycopersicum | Big | Continuous | 8 | 50 | K⁺ | Square | 10% | 127.31 | 1.29 | Germination rate |
| | Beef F1 | | | | | | | | | increased (48%) |
| S. Lycopersicum | Big | Continuous | 15 | 50 | K⁺ | Square | 10% | 127.31 | 0.592 | Germination rate |
| | Beef F1 | | | | | | | | | increased (33%) |
| S. Lycopersicum | Sunny | Continuous | 129 | 16 | NA | Square | 30% | NA | 5 | Total ripe fruit mass |
| | Boy | | | | | | | | | increased (34%) |
| S. Lycopersicum | Sunny | Continuous | 43 | 16 | NA | Square | 30% | NA | 5 | Total ripe fruit mass |
| | Boy | | | | | | | | | increased (27%) |
| Lactuca sativa | Bibb | Sub | 62 | 50 | NA | Sine | 30% | 150 | 2.056 | Total plant vegetative |
| | | Continuous | | | | | | | | mass increased (32%) |
| Lactuca sativa | Bibb | Sub | 62 | 0 | NA | NA | NA | 150 | na | Total plant vegetative |
| | | Continuous | | | | | | | | mass increased (24%) |
| Lactuca sativa | Bibb | Sub | 62 | 16 | K⁺ | Sawtooth | 30% | 40.74 | 0.635 | Total plant vegetative |
| | | Continuous | | | | | | | | mass increased (18%) |
| Lactuca sativa | Bibb | Sub | 12 | 50 | Mg²⁺ | Sine | 30% | 39.57 | 0.747 | Total plant vegetative |
| | | Continuous | | | | | | | | mass increased (17%) |
| Lactuca sativa | Bibb | Sub | 28 | 60 | Mg²⁺ | Square | 10% | 47.48 | 0.26 | Total plant vegetative |
| | | Continuous | | | | | | | | mass increased (12%) |
| Lactuca sativa | Bibb | Sub | 62 | 50 | N⁺ | Sine | 30% | 45.61 | 0.765 | Total plant vegetative |
| | | Continuous | | | | | | | | mass decreased (−41%) |
| Lactuca sativa | Bibb | Sub | 62 | 50 | Fe²⁺ | Sine | 30% | 90.92 | 1.282 | Total plant vegetative |
| | | Continuous | | | | | | | | mass decreased (−42%) |
| Lactuca sativa | Bibb | Sub | 62 | 50 | Cu²⁺ | Sine | 30% | 103.45 | 1.426 | Total plant vegetative |
| | | Continuous | | | | | | | | mass decreased (−44%) |

### Example 2

### EMF Exposure Increases Tomato Mass without Changing Percent Dissolve Solids

Methods:

Tomato plants (Solanum lycopersicum “Sunny Boy F1”) were grown in a greenhouse with natural sunlight. Eight (8) plants received no treatment (“control group”). Eight (8) plants received treatment (“treatment group”) according to the recipe as shown in Table 2. The control group and treatment group were grown under similar lighting, irrigation, water, nutrients, soil pH, EC, temperature, and humidity. The treatment was provided to the treatment group using a parallel transmission line system. The system used has the ability to receive instructions to deploy different recipes and to deploy said recipes at specific times/intervals.

Total dissolved solids was measured using a Hanna Instruments model HI96801 Sugar in foods refractometer; sugar content Range: 0 to 85% Brix (% Brix).

TABLE 2

| | |
|---|---|
| Treatment Schedule | continuous exposure for 129 days |
| Treatment Recipe | Carrier waveform: Sine |
| | Mod frequency: 16 Hz |
| | Mod waveform: Square |
| | Mod depth: 30% |
| | Voltage: 5 Vpp |

Tomato fruit mass increased and dissolved solids in the fruit changed proportionally with mass so that the percent dissolved solids remained the same for the treatment group compared to the control group as shown in Table 3.

TABLE 3

| | | | % |
|---|---|---|---|
| | Treatment | Control | change |
| Avg. tomato mass (g) | 143 ± 9 | 104 ± 6 | 37.9 |
| Total tomato mass (g) | 4568 | 3417 | 33.7 |
| Dissolved solids (° Bx) | 6.53 ± 0.34 | 6.54 ± 0.57 | 0.2 |

1. A plant treatment system configured to treat a plant with an electromagnetic field, the system comprising:
a function generator configured to generate the electromagnetic field; and
one or more radiating structure(s) coupled to the function generator and configured to produce the electromagnetic field for applying to the plant.

2. The plant treatment system of claim 1, further comprising a computational system configured to receive an input specifying parameters for controlling the function generator and to control the function generator to generate an electromagnetic field according to the input.

3. The plant treatment system of claim 2, wherein the computational system is configured to receive a recipe comprising the parameters for controlling the function generator and the parameters specifying a voltage and a optionally a modulating wave.

4. The plant treatment system of claim 2, wherein the computational system is configured to receive more than one recipe comprising the parameters for controlling the function generator and the parameters specifying a carrier wave and a optionally a modulating wave, and control the function generator to generate any one or more of the more than one recipe.

5. The plant treatment system of claim 2, wherein the computational system is configured to receive a schedule for applying the electromagnetic field to the plant.

6. The plant treatment system of claim 5, wherein the computational system is configured to change the electromagnetic field in accordance with the schedule.

7. The plant treatment system of claim 2, wherein the computational system comprises a wireless communication component and is configured to wirelessly receive a recipe and/or schedule.

8. The plant treatment system of claim 7, wherein the recipe is encrypted.

9. The plant treatment system of claim 1, wherein the function generator comprises a Software Defined Radio (SDR) or a transformer.

10. The plant treatment system of claim 1, wherein the system is configured to produce an electromagnetic field.

11. The plant treatment system of claim 1, wherein at least one radiating structure is positioned in close proximity to a plant.

12. The plant treatment system of claim 1, wherein at least one radiating structure is positioned within 15 feet of a plant.

13. The plant treatment system of claim 1, wherein at least one radiating structure comprises copper, galvanized steel, and/or or aluminum.

14. The plant treatment system of claim 1, wherein at least one radiating structure comprises a transmission line, pipe, coil, capacitor, point source antenna, mesh, grounding stake, tape, foil, plate, and/or standard antenna.

15. The plant treatment system of claim 1, wherein the one or more radiating structure comprises a plurality of radiating structures.

16. The plant treatment system of claim 15, wherein at least two of the plurality of radiating structures are at least in part parallel with each other.

17. The plant treatment system of claim 16, wherein the at least two radiating structures comprise parallel transmission lines, parallel pipes, parallel meshes, parallel plates, and/or parallel coils.

18. The plant treatment system of claim 17, wherein the parallel coils are Helmholtz coils.

19. The plant treatment system of claim 1, wherein at least one radiating structure is positioned horizontally or vertically.

20. A method of treating a plant, the method comprising:
producing a treatment electromagnetic field using the plant treatment system of claim 1; and
applying the treatment electromagnetic field to a plant.

21. A method for electromagnetic treatment of a plant, the method comprising:
producing an electromagnetic field; and
applying the electromagnetic field to a plant.

22. The method of claim 21, wherein producing the electromagnetic field comprises modulating a carrier frequency of 0 Hz to 5.875 GHz with a modulating wave to produce the electromagnetic field, wherein the modulating wave comprises a waveform with a modulating frequency of 0 Hz to 1 MHz, a modulating waveform, and/or an amplitude modulating index of 0% to 120%.

23. The method of claim 21, wherein the electromagnetic field matches an ion cyclotron resonance frequency of calcium, potassium, magnesium, iron, copper, and/or nitrogen during at least a portion of the treatment.

24. The method of claim 22, wherein the modulated electromagnetic field has a sine carrier frequency, amplitude modulated at 50 Hz, a square wave modulation waveform, and/or 30% amplitude modulating index, or any combination thereof.

25. The method of claim 21, wherein the treatment is provided as a constant treatment or a treatment that is turned on and/or off or changed with watering cycles for the plant, set timing, an environmental change, and/or stage of the life of the plant.

26. The method of claim 22, wherein the amplitude of the modulated electromagnetic field produced an electromagnetic field configured to be dampened by tissue of the plant.

27. The method of claim 22, wherein modulating the electromagnetic field modulates the carrier amplitude and/or the carrier frequency.

28. The method of claim 21, wherein the treatment comprises a magnetic field.

29. The method of claim 21, wherein the treatment comprises a an electric field, wherein the electric field produced has a strength of −1 MV/m to 1 MV/m at a location where the electric field is produced.

30. The method of claim 21, wherein the carrier waveform and/or a modulating waveform is static, pulsed, square, sine, triangular, sawtooth, damped pulse, rectangular, ramped, cardiogram, or amplitude varying, or any combination thereof.

31. The method of claim 21, wherein the electromagnetic field produced has a strength of at least −110 dBm to at least 20 dBm at a location where the electromagnetic field is produced.

32. The method of claim 22, wherein the method further comprises modulating strength of the modulated electromagnetic field.

33. The method of claim 21, wherein the treatment is applied to a plant for 1 microsecond to 1440 minutes per day.

34. The method of claim 21, wherein the treatment is applied to a plant for at least one day to 12 months.

35. The method of claim 21, wherein the electromagnetic field is produced by at least one of the radiating structure(s).

36. The method of claim 35, wherein at least one radiating structure is positioned in close proximity to the plant.

37. The method of claim 35, wherein at least one radiating structure is positioned within 15 feet of the plant.

38. The method of claim 35, wherein at least one radiating structure is positioned within 3 feet of the plant

39. The method of claim 35, wherein at least one radiating structure comprises a transmission line, pipe, coil, capacitor, point source antenna, mesh, grounding stake, tape, foil, plate, and/or standard antenna.

40. The method of claim 35, wherein the at least one radiating structure comprises a plurality of radiating structures.

41. The method of claim 40, wherein at least two of the plurality of radiating structures are at least in part parallel with each other.

42. The method of claim 41, wherein the at least two radiating structures comprise parallel transmission lines, parallel pipes, parallel coils, parallel antenna, parallel wire meshes, parallel grounding stakes, parallel tapes, parallel foils, and/or parallel plates.

43. The method of claim 42, wherein the parallel coils are Helmholtz coils.

44. The method of claim 35, wherein at least one radiating structure is positioned horizontally or vertically.

45. The method of claim 21, wherein the electromagnetic field mimics a change in the ambient electromagnetic field due to a storm.

46. The method of claim 21, wherein the method modifies weight of at least a portion of the plant, yield of the plant, germination rate, germination timing, membrane permeability, nutrient uptake, gene transcription, gene expression, cell growth, cell division, protein synthesis, latent heat flux, carbon assimilation, stomatal conductance, the chemical profile in at least a portion of the plant, the time required for harvest readiness, quantity of flowering sites, internode spacing, and/or repel and/or decrease the amount of pests on the plant, as compared to a plant that is not treated.

47. The method of claim 21, wherein the treatment is applied to the plant when the plant is a seed, a synthetic seed, a cutting, a seedling, a mature plant, a plant in a flowering stage, a plant in a vegetative stage, and/or a plant in a fruiting stage.

48. The method of claim 21, wherein the plant belongs to a kingdom Plantae.

49. The method of claim 21, wherein the plant belongs to a subkingdom Viridiplantae or any cultivar or subspecies thereof.

50. The method of claim 21, wherein the plant belongs to a infrakingdom Streptophta or any cultivar or subspecies thereof.

51. The method of claim 21, wherein the plant belongs to a superdivision Embryophyta or any cultivar or subspecies thereof.

52. The method of claim 21, wherein the plant belongs to a division Tracheophyta or any cultivar or subspecies thereof.

53. The method of claim 21, wherein the plant belongs to a subdivision Spermatophytina or any cultivar or subspecies thereof.

54. The method of claim 21, wherein the plant belongs to a class Magnoliopsida or any cultivar or subspecies thereof.

55. The method of claim 21, wherein the plant belongs to a superorder selected from Rosanae and Asteranae, or any cultivar or subspecies thereof.

56. The method of claim 21, wherein the plant belongs to an order selected from Rosales, Brassicales, Asterales, Vitales, and Solanales or any cultivar or subspecies thereof.

57. The method of claim 21, wherein the plant belongs to a family selected from Brassicaceae, Asteracae, Vitacaea, Cannabaceae, and Solanacaea or any cultivar or subspecies thereof.

58. The method of claim 21, wherein the plant belongs to a genus selected from Humulus, Brassica, Eruca, Lactuca, Cannabis, Vitis, and Solanum or any cultivar or subspecies thereof.

59. The method of claim 21, wherein the plant belongs to a species Humulus japonicus, Humulus lupulus, Cannabis sativa, Cannabis indica, Cannabis ruderalis, Brassica rapa, Eruca vesicaria, Lactuca biennis, Lactuca canadensis, Lactuca floridana, Lactuca graminifolia, Lactuca hirsute, Lactuca indica, Lactuca ludoviciana, Lactuca X morssii, Lactuca sagilina, Lactuca sativa, Lactuca serriola, Lactuca terrae-novae, Lactuca virosa, Vitis acerifolia, Vitis aestivalis, Vitis amurensis, Vitis arizonica, Vitis X bourquina, Vitis californica, Vitis X champinii, Vitis cinerea, Vitis coriacea, Vitis X doaniana, Vitis girdiana, Vitis labrusca, Vitis X labruscana, Vitis monticola, Vitis mustangensis, Vitis X novae-angliae, Vitis palmata, Vitis riparia, Vitis rotundifolia, Vitis rupestris, Vitis shuttleworthii, Vitis tillifolia, Vitis vinifera, Vitis vulpina, and Solanum lycopersicum, or any cultivar or subspecies thereof.

60. The method of claim 21, wherein the plant is a lettuce, arugula, bok choy, tomato, grape, hops, hemp, or mizuna, or any cultivar or subspecies thereof.

61. The method of claim 21, wherein the plant is spinach, sunflower, canola, flax corn, rice, wheat, oat, barley, soybean, bean, pea, legume, chickpea, sorghum, sugar cane, sugar beet, cotton, potato, turnip, carrot, onion, cantaloupe, watermelon, blueberry, cherry, apple, pear, peach, cacti, date, fig, coconut, almond, walnut, pecan, cilantro, broccoli, cauliflower, zucchini, squash, pumpkin, or any cultivar or subspecies thereof.

62. The method of claim 21, wherein the plant is a tomato plant, a lettuce plant, a strawberry plant, a saffron plant, or a grape plant.

63. The method of claim 21, wherein
the electromagnetic field comprises a sine carrier waveform, and
the modulating wave applied to the carrier waveform comprises a waveform with a modulating frequency of 16 Hz, a modulating waveform of square, and/or an amplitude modulating index of 30%, and
wherein mass of the plant and/or a part of the plant is increased as compared to a plant not treated by the method.

64. The method of claim 63, wherein the plant is a tomato plant and the mass of a tomato fruit is increased.

65. The method of claim 21, wherein the electromagnetic field comprises a field that matches an ion cyclotron resonance frequency of K⁺ during at least a portion of the treatment,
the electromagnetic field comprises a sine carrier waveform, and
the modulating wave applied to the carrier waveform comprises a waveform with a modulating frequency of 50 Hz, a modulating waveform of square, an amplitude modulating index of 10%, and/or a nominal field strength of 127.31 micro tesla, and
wherein germination rate is increased as compared to a plant not treated by the method.

66. The method of claim 65, wherein the plant is a tomato plant.

67. The method of claim 21, wherein
the electromagnetic field is generated by modulating a carrier wave with a DC signal, and/or has a nominal field strength of 150 micro tesla, and
wherein mass of the plant and/or part of the plant is increased, as compared to a plant not treated by the method.

68. The method of claim 67, wherein the plant is a lettuce plant and the total plant vegetative mass is increased.

69. The method of claim 21, wherein the electromagnetic field comprises a field that matches an ion cyclotron resonance frequency of K⁺ during at least a portion of the treatment,
the electromagnetic field comprises a sine carrier waveform, and
the modulating wave comprises a waveform with a modulating frequency of 16 Hz, a modulating waveform of sawtooth, an amplitude modulating index of 30%, and/or a nominal field strength of 40.74 micro tesla, and
wherein mass of the plant and/or part of the plant is increased, as compared to a plant not treated by the method.

70. The method of claim 69, wherein the plant is a lettuce plant and the total plant vegetative mass is increased.

71. The method of claim 21, wherein the electromagnetic field comprises a field that matches an ion cyclotron resonance frequency of Mg²⁺ during at least a portion of the treatment,
the electromagnetic field comprises a sine carrier waveform, and
the modulating wave comprises a waveform with a modulating frequency of 60 Hz, a modulating waveform of square, an amplitude modulating index of 10%, and/or a nominal field strength of 47.48 micro tesla, and
wherein mass of the plant and/or part of the plant is increased, as compared to a plant not treated by the method.

72. The method of claim 71, wherein the plant is a lettuce plant and the total plant vegetative mass is increased.

73. The method of claim 21, wherein
the electromagnetic field comprises a sine carrier waveform, and
the electromagnetic field comprises a waveform with a modulation frequency of 50, a modulating waveform of sine, an amplitude modulating index of 30%, and/or a nominal field strength of 150 micro tesla, and
wherein mass of the plant and/or part of the plant is increased, as compared to a plant not treated by the method.

74. The method of claim 73, wherein the plant is a lettuce plant and the total plant vegetative mass is increased.

75. The method of claim 21, wherein the electromagnetic field comprises a field that matches an ion cyclotron resonance frequency of Mg²⁺ during at least a portion of the treatment,
the electromagnetic field comprises a sine carrier waveform, and
the modulating wave comprises a waveform with a modulating frequency of 50 Hz, a modulating waveform of sine, an amplitude modulating index of 30%, and/or a nominal field strength of 39.57 micro tesla, and
wherein mass of the plant and/or part of the plant is increased, as compared to a plant not treated by the method.

76. The method of claim 75, wherein the plant is a lettuce plant and the total plant vegetative mass is increased.

77. The method of claim 21, wherein the electromagnetic field comprises a field that matches an ion cyclotron resonance frequency of K⁺ during at least a portion of the treatment,
the electromagnetic signal comprises a DC signal modulated by a waveform with a modulating frequency of 60 Hz, a modulating waveform of sine, an amplitude modulating index of 30%, and/or a nominal field strength of 152.8 micro tesla, and
wherein a pest is repelled and/or the number of pests on and/or in the plant is decreased, as compared to a plant not treated by the method.

78. The method of claim 77, wherein the pest is an aphid and/or spider mite.

79. The method of claim 21, wherein the electromagnetic field comprises a field that matches an ion cyclotron resonance frequency of N⁺ during at least a portion of the treatment,
the electromagnetic field comprises a sine carrier waveform, and
the modulating wave comprises a waveform with a modulating frequency of 50, a modulating waveform of sine, an amplitude modulating index of 30%, and/or a nominal field strength of 45.61 micro tesla, and
wherein mass of the plant and/or part of the plant is decreased, as compared to a plant not treated by the method.

80. The method of claim 79, wherein the plant is a lettuce plant and the total plant vegetative mass is decreased.

81. The method of claim 21, wherein the electromagnetic field comprises a field that matches an ion cyclotron resonance frequency of Fe²⁺ during at least a portion of the treatment,
the electromagnetic field comprises a sine carrier waveform, and
the modulating wave comprises a waveform with a modulating frequency of 50, a modulating waveform of sine, an amplitude modulating index of 30%, and/or a nominal field strength of 90.92 micro tesla, and
wherein mass of the plant and/or part of the plant is decreased, as compared to a plant not treated by the method.

82. The method of claim 81, wherein the plant is a lettuce plant and the total plant vegetative mass is decreased.

83. The method of claim 21, wherein the electromagnetic field comprises a field that matches an ion cyclotron resonance frequency of Cu²⁺ during at least a portion of the treatment,
the electromagnetic field comprises a sine carrier waveform, and
the modulating wave comprises a waveform with a modulating frequency of 50, a modulating waveform of sine, an amplitude modulating index of 30%, and/or a nominal field strength of 103.45 micro tesla, and
wherein mass of the plant and/or part of the plant is decreased, as compared to a plant not treated by the method.

84. The method of claim 83, wherein the plant is a lettuce plant and the total plant vegetative mass is decreased.

85. The method of claim 21, wherein the total consumption of energy to produce the modulated electromagnetic field is 1000 watts/100 ft² or less, preferably 100 watts/100 ft² or less, or more preferably 75 watts/100 ft² to 50 watts/100 ft², or more preferably 40 watts/100 ft² to 60 watts/100 ft².

86. The method of claim 21, further comprising producing the modulated electromagnetic field by the plant treatment system of any one of claims 1 to 20.
